(19) United States
(12) Patent Application Publication
(10) Pub. No.: US 2023/0231824 A1
(43) Pub. Date: Jul. 20, 2023

(54) MANAGING A PLURALITY OF SOCIAL MEDIA TIMELINES OF A MESSAGING PLATFORM

(71) Applicant: Twitter, Inc., San Francisco, CA (US)

(72) Inventors: Jose Antonio Marquez, Weehawken, NJ (US); Nicholas Lockington, London (GB); Paul Oglesby, Brighton (GB); Tiago Engel, London (GB)

(21) Appl. No.: 17/659,584

(22) Filed: Apr. 18, 2022

Related U.S. Application Data
(60) Provisional application No. 63/266,916, filed on Jan. 19, 2022.

(51) Int. Cl. H04L 51/52; G06F 3/0482; H04L 51/216; G06F 3/0484

(52) U.S. Cl. CPC H04L 51/52; G06F 3/0482; H04L 51/216; G06F 3/0484

(57) ABSTRACT

This disclosure relates to a messaging system that can generate, store, and share groups of display columns associated with a user account, where each group may include a single display column or two or more display columns. A method may include rendering a first group of display columns of a messaging platform on a user interface associated with a first computing device, transmitting group creation data for creating a second group of display columns of the messaging platform, rendering a list identifying the first group of display columns and the second group of display columns, and rendering, in response to selection of the second group from the list, the second group of display columns on the user interface.

### CROSS-REFERENCE TO RELATED APPLICATION

This application claims priority to U.S. Provisional Patent Application No. 63/266,916, filed on Jan. 19, 2022, entitled “MANAGING A PLURALITY OF SOCIAL MEDIA TIMELINES OF A MESSAGING PLATFORM”, the disclosure of which is incorporated by reference herein in its entirety.

### BACKGROUND

A social media messaging platform may facilitate the exchange of millions or hundreds of millions of social media messages among its users. The messages exchanged on the platform often can provide users of the platform the latest update or reporting on current events. In some examples, a user may submit a search on the platform and receive a stream of results such that the user can view messages over time that match one or more keywords. In some examples, a user may create multiple searches and then receive and display the search results in separate timelines on a user interface. However, managing multiple timelines for a particular user or multiple users involves complex and technical challenges such as processing speed, computer resource allocation, and/or security issues.

### SUMMARY

According to an aspect, a method for managing groups of display columns in a messaging platform includes rendering a first group of display columns of a messaging platform on a user interface associated with a first computing device, transmitting group creation data for creating a second group of display columns of the messaging platform, and rendering a list identifying the first group of display columns and the second group of display columns. The first and second groups of display columns are associated with a first user account. The method includes rendering, in response to selection of the second group from the list, the second group of display columns on the user interface, where each of the second group of display columns displays a separate timeline of messages posted to the messaging platform by other user accounts.

According to some aspects, the method may include one or more of the following features (or any combination thereof). The method may include rendering a first user interface (UI) object on the user interface, the first UI object providing an option to add a first display column to the second group, and rendering a second UI object on the user interface, the second UI object providing an option to define a plurality of filter parameters of the first display column, wherein the group creation data includes one or more of the plurality of filter parameters. The method may include rendering, in response to selection of the first group from the list, the first group of display columns on the user interface in replace of the second group of display columns, each of the first group of display columns displaying a separate timeline of messages posted to the messaging platform by other user accounts. The method may include rendering a user interface (UI) object on the user interface, the UI object providing an option to share a display column of the second group with other users of the messaging platform, and transmitting, over a network, a message to a second computing device associated with a second user account, the message including a resource locator identifier, which, when selected, is configured to provide an option to add the display column of the second group to a user account of the messaging platform. The method may include rendering a user interface (UI) object on the user interface, the UI object providing an option to share the second group with other users of the messaging platform, and transmitting, over a network, a message to a second computing device associated with a second user account, the message including a resource locator identifier, which, when selected, is configured to provide an option to add the second group to a user account of the messaging platform. The first group of display columns may be created by a second user account of the messaging platform. The method may include rendering a message on the user interface, the message having been posted to the messaging platform by a second user account, the message including a resource locator identifier, rendering, in response to selection of the resource locator identifier, a user interface (UI) object that provides an option to add the first group of display columns to the first user account, and identifying the first group of display columns in the list in response to selection of the option to add the first group of display columns to the first user account. One or more attributes of a display column belonging to the first group may not be modifiable by the first user account. The method may include providing selection of one or more of a plurality of groups of display columns offered by a store platform, the plurality of groups of display columns being available to be added to the first user account, receiving a selection to a third group of display columns from the plurality of groups of display columns offered by the store platform, and identifying the third group of display columns in the list on the user interface.

According to an aspect, an apparatus includes at least one processor and a non-transitory computer-readable medium storing executable instructions that when executed by the at least one processor cause the at least one processor to associate a group identifier of a first group of display columns with a first user account in a data store of a messaging platform, the data store associating display columns belonging to the first group with the group identifier, the first group of display columns defining filter parameters, associate, in response to a request to add the first group to a second user account, a share group identifier to the second user account, the share group identifier identifying the group identifier, identify, in response to receipt of a group selection request from a second computing device associated with the second user account, the first group of display columns using the share group identifier, and transmit, over a network, group data to the second computing device, the group data configured to cause the first group of display columns to be rendered on the second computing device such that messages are streamed into the first group of display columns according to the filter parameters.

According to some aspects, the apparatus may include one or more of the following features (or any combination thereof). The first group of display columns is shared with the second user account using the share group identifier such that the display columns belonging to the first group are not duplicated and stored in association with the second user account in the data store. The executable instructions include instructions that when executed by the at least one processor cause the at least one processor to transmit, over a network, a message to the second computing device, the message including a resource locator identifier, which, when selected, is configured to provide an option to add the first group to the second user account. The executable instructions include instructions that when executed by the at least one processor cause the at least one processor to update a profile of the first user account to display information about the first group, the information about the first group including the resource locator identifier. The filter parameters of the first group of display columns are not modifiable by the second user account. The filter parameters of the first group of display columns are modifiable by the first user account. The executable instructions include instructions that when executed by the at least one processor cause the at least one processor to identify that the group selection request is from the second user account, determine that the share group identifier is associated with the second user account from the data store, identify the group identifier from the data store using the share group identifier, identify column identifiers of the display columns belonging to the first group from the data store using the group identifier, and obtain attributes of the first group of display columns from the data store using the column identifiers, the attributes including the filter parameters. The first group of display columns include a first display column that displays messages posted to the messaging platform that satisfy a first search query and a second display column that displays messages posted to the messaging platform that satisfy a second search query, where the first display column and the second display column are configured to be displayed simultaneously.

According to an aspect, a non-transitory computer-readable medium storing executable instructions that when executed by at least one processor causes the at least one processor to execute operations. The operations include receive, over a network, group creation data for creating a first group of display columns of a messaging platform from a client application executable by a first computing device, update a data store of the messaging platform to associate a user account with the first group of display columns, the user account being associated with a second group of display columns, and transmit, over the network, group list data to the client application, the group list data configured to cause the client application to render a list identifying the first group of display columns and the second group of display columns.

According to some aspects, the non-transitory computer-readable medium includes one or more of the following features (or any combination thereof). The second group of display columns is created by a second user account associated with a second computing device. The operations may include transmit, over the network, a message to the second computing device, the message including a resource locator identifier, which, when selected, is configured to provide an option to add the first group to the second user account, update, in response to receipt of the option to add the first group, the data store to associate the second user account with the first group, and transmit, in response to receipt of a group selection request from the second computing device, group data to the second computing device, the group data configured to cause the first group of display columns to be rendered on the second computing device such that messages are streamed into the first group of display columns.

According to an aspect, a method for managing groups of display columns in a messaging platform includes transmitting group creation data for creating a first group of display columns of a messaging platform, the first group of display columns being associated with a first user account of the messaging platform, rendering a list identifying the first group of display columns and a second group of display columns on a user interface, and rendering, in response to selection of the first group from the list, the first group of display columns on the user interface, each of the first group of display columns displaying a separate timeline of messages to the messaging platform by other user accounts.

### BRIEF DESCRIPTION OF DRAWINGS

FIG. 1A illustrates a messaging system for managing and sharing groups of display columns in a messaging platform according to an aspect.

FIG. 1B illustrates an example of a group of display columns according to an aspect.

FIG. 1C illustrates an example of another group of display columns according to an aspect.

FIG. 1D illustrates an example of a data store that links groups with user accounts and links display columns with groups according to an aspect.

FIG. 1E illustrates an example of a data store in response to a follow request or a request to create a local version of a shared group according to an aspect.

FIG. 1F illustrates an example of a store platform that offers groups and display columns for selection according to an aspect.

FIG. 1G illustrates an example of a group suggestion unit for recommending groups and/or display columns according to an aspect.

FIG. 2 illustrates an example of an event producer system according to an aspect.

FIGS. 3A through 3I illustrate examples of user interfaces for creating and displaying groups of display columns according to various aspects.

FIGS. 4A through 4K illustrate examples of user interfaces for sharing groups and/or display columns on a messaging platform according to various aspects.

FIG. 5A through 5E illustrate examples of user interfaces for following and rendering shared groups and/or shared display columns according to various aspects.

FIG. 6 illustrates a flowchart depicting example operations of managing groups of display columns according to an aspect.

FIG. 7 illustrates a flowchart depicting example operations of sharing a group of display columns according to an aspect.

### DETAILED DESCRIPTION

This disclosure relates to a messaging system that can generate, store, and share groups of display columns associated with a user account, where each group may include a single display column or two or more display columns. The messaging system may provide technical benefits of reducing the amount of memory (and processing power) required to store groups of display columns for a large number of users (e.g., thousands, millions, hundreds of millions, etc.). Also, the messaging system provides technical benefits of increasing the computing speed of switching between multiple search queries that match content in a large message stream (e.g., switching between a first group configured to filter messages into multiple display columns, and a second group configured to filter messages into different, multiple display columns). Further, the messaging system provides a technical solution for sharing groups of display columns among the messaging platform's users in a manner that increases the security of the messaging platform and reduces the amount of memory (and processing power) for enabling the distribution of groups of display columns among the users of the messaging system.

When a particular group of display columns is selected and then rendered on a computing device of a user, two or more display columns may be rendered simultaneously on a display of the computing device. A display column may display messages posted to a messaging platform that satisfy a search query. For example, when a display column is displayed (e.g., visibly displayed) on the computing device, an active query is executed by the messaging platform in which messages that satisfy the search query are streamed to the respective display column so that a user can view a message that has been posted to the messaging platform in real-time or near real-time.

Each display column may correspond to (or include) a separate social media timeline (e.g., a timeline of social media content exchanged on the messaging platform). In some examples, a social media timeline may be a list (e.g., ordered list) of messages posted to the messaging platform. In some examples, the messages are arranged in chronological order or reverse chronological order. In some examples, the messages are ranked according to one or more ranking signals. As the display column continues to be displayed, messages that satisfy the search query can be streamed into the display column at the time (or around the time) they are posted to the messaging platform. One display column may display the user's home timeline (e.g., messages from user accounts that are connected to the user account of the user in a connection graph), another display column may display messages that satisfy one or more search terms entered into a search field by the user, and another display column may display messages or entities (e.g., named entities, hashtags, user accounts) that are identified as trending by the messaging platform.

A group of display columns may refer to a set, a deck, a collection, a batch, or a pack of display columns, where user selection of the group causes all the display columns associated with the respective group to be rendered on the display simultaneously. A first group of display columns may relate to Milwaukee Bucks Basketball™ (e.g., titled “Milwaukee Bucks Basketball™”), where a user has created a first display column that display messages that satisfy a first search query (e.g., “Giannis Antetokounmpo”), a second display column that displays messages that satisfy a second search query (e.g., “Bobby Portis”), and a third display column that displays messages that satisfy a third search query (e.g., “Bucks™”). Messages that are posted to the messaging platform can be identified as containing “Giannis Antetokounmpo”, “Bobby Portis” and “Bucks™”, and those messages are streamed to their respective display columns (e.g., social media timelines). As indicated above, besides defining search criteria that is used to search and filter the messages posted to the messaging platform according to one or more search terms, the column's search query may specify to render messages from the user's home timeline, messages from the user's direct messages, messages from a predefined list of user accounts associated with a particular topic, messages that the user has bookmarked, notification messages, messages posted to the user's profile, scheduled messages, or messages (or entities, hashtags, or user accounts, etc.) that are trending on the messaging platform.

A client application (e.g., a website executing on a web browser, a native application) may render a list of one or more groups of display columns associated with a user account of the messaging platform. The list may include the first group (e.g., titled “Milwaukee Bucks Basketball™”), a second group (e.g., titled “Food Scene in LA”), and a third group (e.g., titled “Green Bay Packers™”), and so forth. In response to the selection of the first group, the client application may render all the display columns associated with the first group (e.g., simultaneously), where each display column displays messages according to its respective search and filter parameters. Then, in response to the selection of the second group, the client application may render all the display columns associated with the second group (to replace the first group's display columns). Then, in response to the selection of the third group, the client application may render all the display columns associated with the third group (to replace the second group's display columns).

The messaging platform may create and store the first group of display columns and link the first group of display columns to the user account of the user. For example, the user account of the user may be linked to a group identifier of the first group of display columns. In some examples, the first group's identifier is linked to the display columns, e.g., the column identifiers of the first display column, the second display column, and the third display column. The column identifiers may identify the computing objects that define the display columns (including any attributes that define a respective display column). In other words, the data store may store user-to-group mappings and columns-to-group mappings.

In some examples, when a particular group or display column is made public or shareable, the data store may be updated with a share group identifier (or share column identifier) that is used to link the shared group (or column) with other user accounts. The share group identifier (or the share column identifier) is an identifier that points to (or references or identifies) the group identifier. When a user makes a group or display column public (or shareable), the share group identifier (or the share column identifier) is generated and stored in the data store. Then, the user has the ability to share the group or column on the messaging platform. For example, the user can post a message about the shared group or display column, which can be transmitted to the user accounts that are connected to the user account of the user in a connection graph. In some examples, when the group or display column is public, information about the shared group or display column is included on the user's profile. In some examples, the user can send a direct message to other user accounts of the messaging platform.

In some examples, the information on the user's profile or the message about the shared group or column may include a resource locator identifier (e.g., a uniform resource locator (URL), or URL pattern). When the resource locator identifier is selected, a UI object may be displayed that provides an option to add the shared group or display column to their user account. In response to receipt of the option to add the shared group or display column, the data store may be updated to link the shared group or column to the user account. In some examples, the share group identifier (or the share column identifier) is linked to the user account. In contrast, the group identifier is linked to the owner's or creator's user account. In this manner, the messaging platform may avoid creating duplicate groups or display columns while providing owner accounts with control on how a particular group or display column can be modified. These and other features are further explained with reference to the figures.

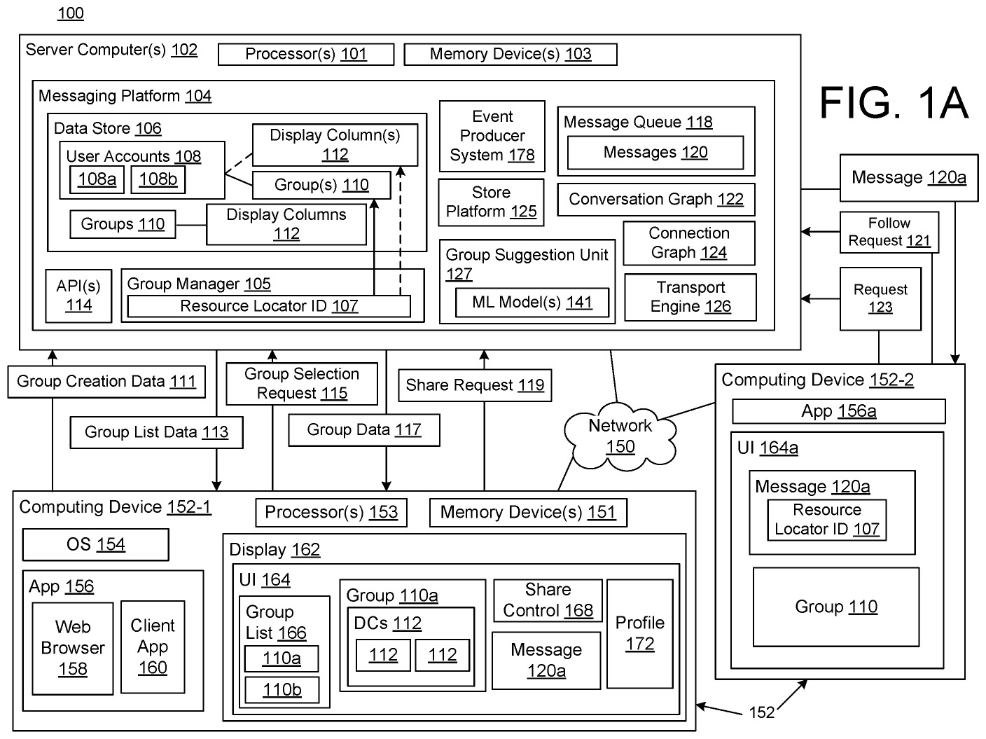

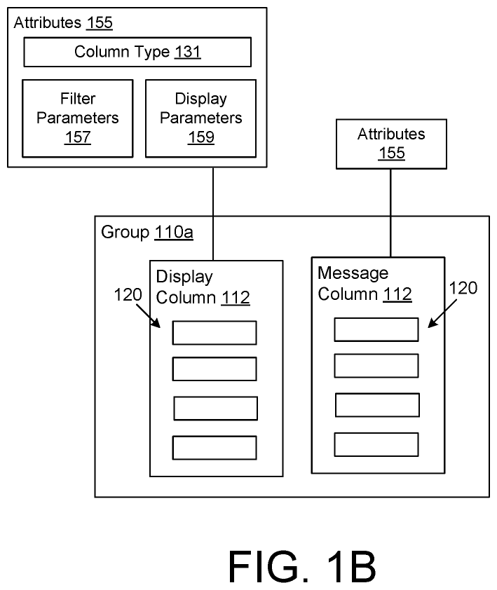

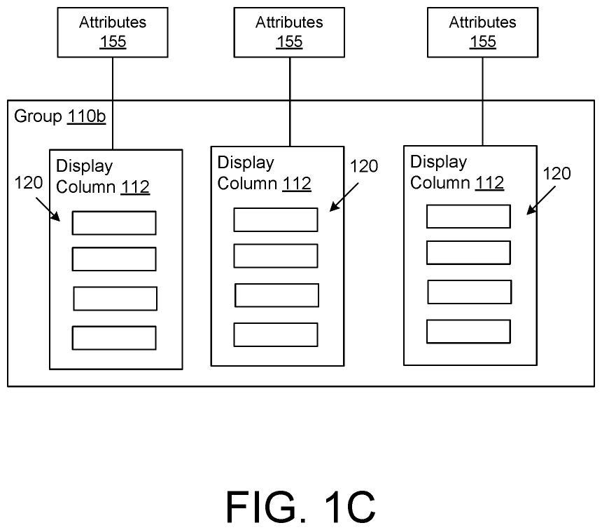

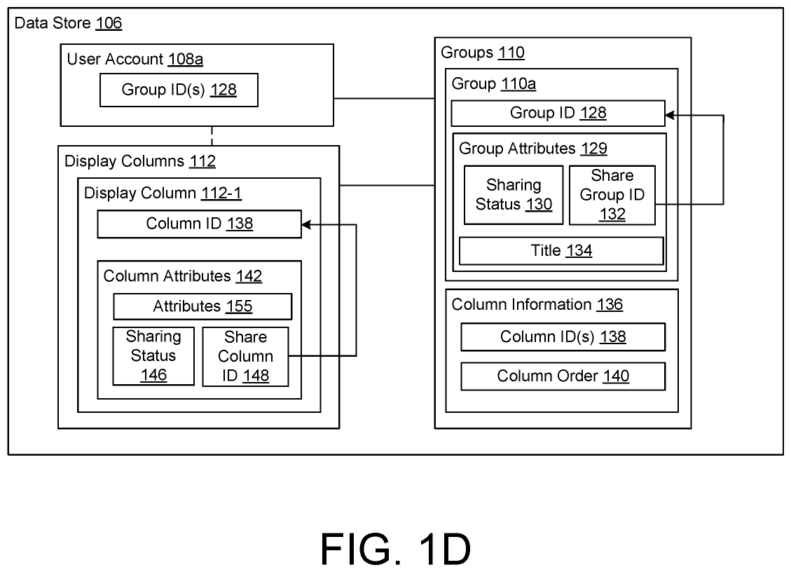

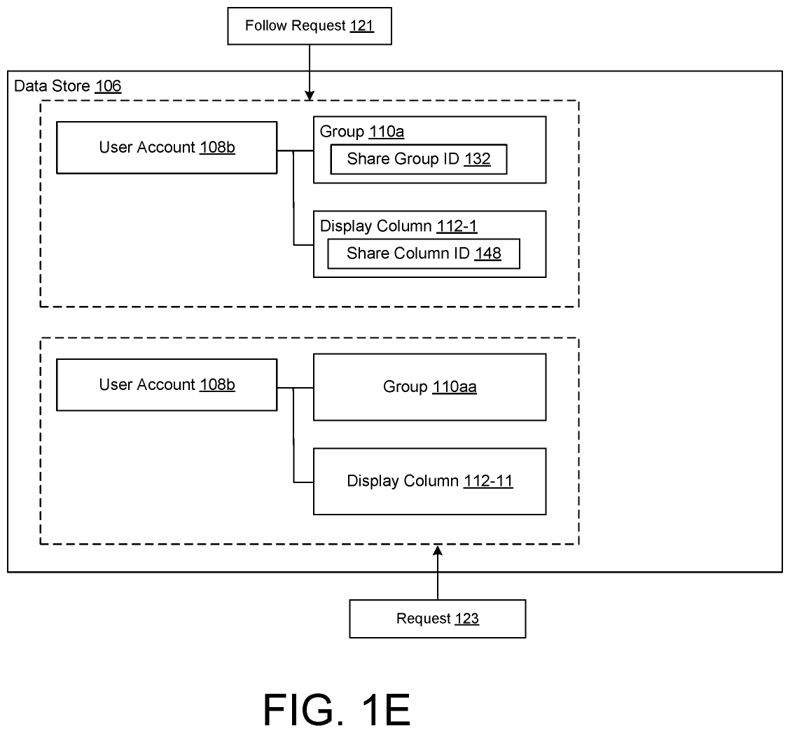

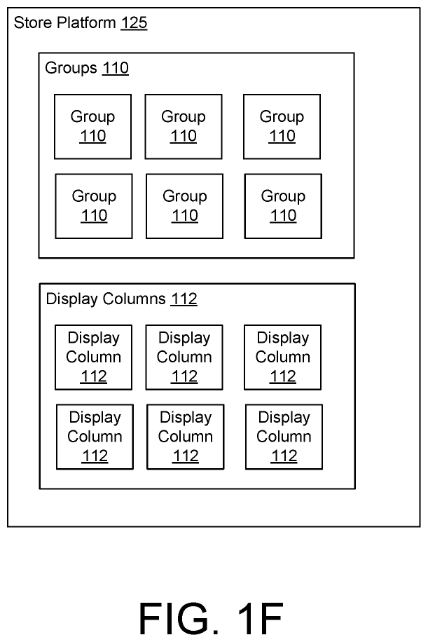

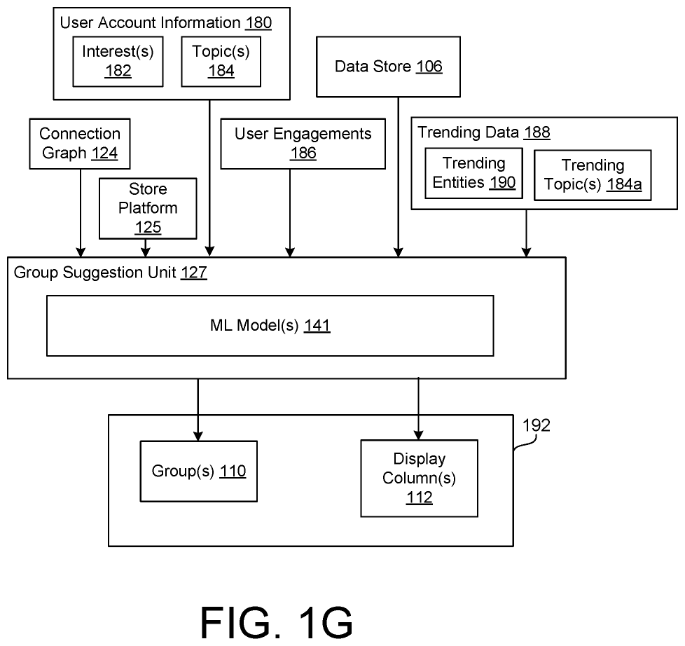

FIGS. 1A through 1G is a schematic diagram of a messaging system 100 for managing display columns (DCs) 112 and groups 110 of display columns 112 according to an aspect. The messaging system 100 includes a messaging platform 104 executable by one or more server computers 102 and computing devices 152 configured to communicate with the messaging platform 104 over a network 150.

The messaging system 100 can generate, store, and/or share groups 110 of display columns 112 associated with a user account 108. The messaging system 100 may reduce the amount of memory (and processing power) required to store groups 110 of display columns 112 for a large number of user accounts 108 (e.g., thousands, millions, etc.), increase the computing speed of switching between groups 110, and enable the sharing of groups 110 with other user accounts 108 of the messaging platform 104 in a manner that reduces the amount of memory (and processing power) to distribute the groups 110 to other user accounts 108.

The messaging platform 104 is a platform for facilitating real-time communication between the computing devices 152. In some examples, the messaging platform 104 is a social media platform or social media website. The messaging platform 104 may store millions of user accounts 108 of individuals, businesses, and/or entities (e.g., pseudonym accounts, novelty accounts, etc.). One or more users of each user account 108 may use the messaging platform 104 to send messages to other user accounts 108 inside and/or outside of the messaging platform 104. The messaging platform 104 may be configured to enable users to communicate in “real-time”, i.e., to converse with other users with minimal delay and to conduct a conversation with one or more other users during simultaneous sessions. In other words, the messaging platform 104 may allow a user to broadcast messages 120 and may display the messages 120 to one or more other users within a reasonable time frame to facilitate a live conversation between users. In some examples, recipients of a message 120 may have a predefined graph relationship in a connection graph 124 with a user account 108 of the user broadcasting the message 120.

The messages 120 may refer to message creation events such as the creation and posting of new messages to the messaging platform 104. In some examples, the messages 120 may refer to re-share events such as the re-sharing of previously posted messages on the messaging platform 104. In some examples, the messages 120 may refer to engagement events such as the favoritizing or liking of previously posted messages on the messaging platform 104.

The messaging platform 104 may include a message queue 118 that stores the messages 120 (e.g., all the messages 120) posted to the messaging platform 104. In some examples, the messages 120 in the message queue 118 may be referred to as a stream of messages that are exchanged by the messaging platform 104 over time. In some examples, the message stream is a large stream of all the message 120 generated on the messaging platform 104. In some examples, the message stream includes messages delivered at a rate over 10 k messages per second. In some examples, the message stream includes messages delivered at a rate over 25 k messages per second. In some examples, the message stream includes messages delivered at a rate over 50 k messages per second. In some examples, the message stream includes message creation events for messages created and posted on the messaging platform 104, message re-share events for existing messages that are re-shared on the messaging platform 104, and/or engagement events for existing messages that are favoritized or liked on the messaging platform 104.

Examples of the computing devices 152 are shown with respect to computing device 152-1 and computing device 152-2. The computing device 152-1 may be used to create, display, and share groups 110 of display columns 112. If a group 110 is created, a user account 108 (e.g., user account 108a) of the user of the computing device 152 is linked to the group 110. The computing device 152-2 may be used to discover shared groups 110 of display columns 112, associate one or more groups 110 to a user account 108 (e.g., user account 108b) associated with the computing device 152-2, and/or display shared groups 110. The computing device 152-2 may be an example of the computing device 152-1 and may include any of the features discussed with reference to the computing device 152-1 (and vice versa).

The computing device 152-1 includes an operating system 154 configured to execute one or more applications 156. In some examples, an application 156 is configured to communicate with the messaging platform 104 over the network 150 and renders information from the messaging platform 104 on a user interface 164 associated with the messaging platform 104. In some examples, the application 156 is a web browser 158 that renders a website of the messaging platform 104 on the user interface 164. In some examples, the application 156 is a web application or browser extension of the web browser 158. In some examples, the application 156 is a native application (e.g., non-web browser application) installed on the operating system 154 of the computing device 152-1. The computing device 152-1 may access the messaging platform 104 via the network 150 using any type of network connections and/or application programming interfaces (APIs) in a manner that permits the application 156 and the messaging platform 104 to communicate with each other.

The application 156 is configured to render one or multiple timelines of a user account 108a on a user interface 164 of the application 156, where each timeline is displayed in a separate display column 112. In some examples, a timeline is a search timeline that displays messages 120 from the message queue 118 that matches one or more search terms provided by the user. In some examples, a timeline is a home timeline of the user account 108a in which the application 156 displays messages 120 from user accounts 108 linked to the user account 108a in the connection graph 124 stored at the messaging platform 104. In some examples, a timeline is a direct message timeline in which the application 156 displays messages 120 sent directly to the user account 108a. In some examples, a timeline includes messages 120 within a conversation graph 122 relating to a conversation on the messaging platform 104. The conversation graph 122 may define a reply structure of messages 120 relating to a conversation. In some examples, the messages 120 relating to the conversation may be automatically pushed to the user interface 164 as users are replying to messages 120 in the conversation graph 122.

A user may use the computing device 152-1 create one or more groups 110 of display columns 112, where the groups 110 are linked to the user account 108a. Selection of a group 110a causes the application 156 to render a multi-column layout of display columns 112 associated with the group 110a on the user interface 164 of the application 156. Selection of a group 110b causes the application 156 to render a multi-column layout of display columns 112 associated with the group 110b on the user interface 164 of the application 156.

A user can make their group(s) 110 shareable (e.g., public) so that other users can discover the shared groups 110 and add the shared group(s) 110 to their user accounts 108. In some examples, a user can make a particular display column 112 shareable (e.g., public) so that other users can discover the shared display column 112 and add the shared display column 112 to their user accounts 108. For example, in response to selection of a share control 168, a group 110 can be shared with other user accounts 108 (e.g., user account 108b) of the messaging platform 104. For example, if a particular group 110 is made shareable (e.g., public), the user of the computing device 152-1 can post a message 120a about the group 110 to the messaging platform 104, where the message 120a can be discovered by other user accounts 108 (e.g., user account 108b) using the messaging platform 104. In some examples, the message 120a is transmitted to computing devices 152 associated with user accounts 108 (which may include user account 108b) that are linked to the user account 108a in the connection graph 124. In some examples, the shared group 110 may be rendered on a profile 172 of the user account 108a, which can be discoverable by the user of the computing device 152-2. In some examples, the user of computing device 152-1 can send the message 120a as a direct message to the computing device 152-2 associated with the user account 108b.

A user of the computing device 152-2 may communicate with the messaging platform 104 to view social media data provided by the messaging platform 104 to discover the shared group(s) 110. For example, the message 120a may appear in a timeline or the direct messages of the user account 108b. In some examples, the shared group(s) 110 may be discoverable by visiting the profile 172 of the user account 108a. If the user of the computing device 152-2 follows (or adds or links to) the shared group 110, the user account 108b is linked with the shared group 110. In some examples, the linking of the shared group 110 with the user account 108b allows the shared group 110 to be displayed on a user interface 164a associated with the computing device 152-2.

In some examples, if a particular group 110 is made shareable, a resource locator identifier 107 is generated, where the resource locator identifier 107 provides a link to the shared group 110. The resource locator identifier 107 may be included in the message 120a about the shared group 110. In some examples, the resource locator identifier 107 includes a uniform resource locator (URL) pattern. In response to the selection of the resource locator identifier 107, the application 156a may render a UI object to display a selectable control to link the shared group 110 to the user account 108b. After the shared group 110 is linked to the user account 108b, the shared group 110 can be selected by the user of the computing device 152-2, which would render the display columns 112 in the same multi-column layer as created by the user account 108a. Any updates to the group 110 (made by user account 108a) would automatically be applied to the group 110 that is shared with any user accounts 108 that are linked to the group 110. In some examples, only the owners (or creators) of shared groups 110 can make changes, and the shared groups 110 can only be viewed by followers (e.g., follower accounts cannot make changes to shared groups 110).

A user may use the application 156 to create a group 110 of display columns 112. A user may create a group 110 by selecting a UI object for creating a new group 110, which may prompt another UI object to allow the user to create a title for the group 110. In some examples, a user can specify an icon for the group 110. Then, the user may be able to add one or more display columns 112 to the group 110. In some examples, the group 110 includes two or more display columns 112, e.g., a first display column and a second display column. In some examples, the group 110 includes a single display column 112. Each display column 112 may correspond to (or include) a separate social media timeline. A social media timeline may be a stream (e.g., an ordered stream) of messages 120 that have been posted to the messaging platform by users of the messaging platform 104. In some examples, the messages of the social media timeline are arranged in chronological order. In some examples, the messages of the social media timeline are arranged in chronological order. In some examples, the messages of the social media timeline are arranged according to a ranking (e.g., the messages are ranked according to one or more ranking signals).

A group 110 of display columns 112 may refer to a set, a deck, a collection, a batch, or a pack of display columns 112. The group 110 may be associated with a title, a description, and be linked to one or more user accounts 108. As shown in FIG. 1A, the user account 108a may be associated with a group 110a and a group 110b. However, the user account 108 may be associated with any number of groups 110. Referring to FIG. 1B, the user may create the group 110a of display columns 112 by selecting, for each display column 112, a column type 131 and/or defining attributes 155 of a respective display column 112. As shown in FIG. 1B, the group 110a includes two display columns 112, which, when the group 110a is selected from a group list 166, causes the display columns 112 to be simultaneously displayed on the user interface 164. As shown in FIG. 1C, the group 110b includes three display columns 112, which, when the group 110b is selected from the group list 166, causes the display columns 112 to be simultaneously displayed on the user interface 164. Each display column 112 provides a separate timeline of messages 120 according to their respective attributes 155.

As the display column 112 continues to be displayed, messages 120 that satisfy the attributes 155 can be streamed into the display column 112 at the time (or around the time) they are posted to the messaging platform 104. One display column 112 may display the user's home timeline (e.g., messages from user accounts 108 that are connected to the user account 108 of the user in the connection graph 124), another display column 112 may display messages 120 that satisfy one or more search terms entered into a search field by the user, another display column 112 that displays messages or entities (e.g., named entities, hashtags, user accounts) that are identified as trending by the messaging platform 104.

To create a display column 112 of a group 110, the user may specify attributes 155 for the display column 112. The attributes 155 may include a column type 131. The column type 131 may be a first type (e.g., a search) that renders messages 120 from the message queue 118 that contain or more search terms entered by a user. The column type 131 may be a second type (e.g., a list) that renders messages from a predefined list of user accounts 108 associated with a particular topic. The column type 131 may be a third type (e.g., bookmarks) that renders messages that the user has bookmarked. The column type 131 may be a fourth type (e.g., profile) that renders messages from the profile 172 of the user account 108a. The column type 131 may be a fifth type (e.g., notifications) that renders notification messages associated with the user account 108a. The column type 131 may be a sixth type (e.g., drafts) that renders draft messages (e.g., drafted but not posted) associated with the user account 108a. The column type 131 may be a seventh type (e.g., home) that renders messages from the home timeline of user account 108a. The column type 131 may be an eighth type (e.g., explore) that renders information that identify trending entities, hashtags, and/or user accounts 108 on the messaging platform 104. The column type 131 may be a ninth type (e.g., scheduled messages) that renders messages, associated with the user account 108a, that are scheduled to be posted to the messaging platform 104. The column type 131 may be a tenth type (e.g., direct messages) that renders messages sent directly to the user account 108a.

In some examples, the attributes 155 include filter parameters 157 and/or display parameters 159. The filter parameters 157 may specify how the messages for a particular display column 112 is filtered. In some examples, the filter parameters 157 include one or more search terms entered by the user. In some examples, the filter parameters 157 may include one or more terms to be included within the messages 120, one or more terms to be excluded from the messages 120, time information (e.g., recently, within a certain time frame, etc.), location information (e.g., messages from a certain geographical location), only messages 120 with media (e.g., video, images, audio, etc.), and/or whether messages 120 can be new messages, replies, re-shares, and/or favoritized messages. The display parameters 159 may specify one or more dimensions (e.g., size, width) of the display column 112, the order of messages (e.g., top messages first, latest messages first, etc.), a media preview size (e.g., small standard), and/or a column name.

Referring back to FIG. 1A, as the user creates a new group 110 and adds display columns 112 to the group 110, the computing device 152-1 (e.g., the application 156) transmits group creation data 111, over the network 150, to the messaging platform 104. In some examples, the group creation data 111 may include a title for the group 110. In some examples, the group creation data 111 may include an icon that represents the group 110. In some examples, the group creation data 111 may include information about a display column 112 that is added to the group 110 such as one or more attributes 155, which may include the column type 131, the filter parameter(s) 157, and/or the display parameter(s) 159.

In some examples, the messaging platform 104 may include one or more application programming interfaces (APIs) 114 and a group manager 105 configured to manage the groups 110 and display columns 112 added by the user accounts 108 based on information received via the API(s) 114. The application 156 may use the API(s) 114 to transmit information to (and from) the messaging platform 104 (e.g., the group manager 105). In some examples, the group manager 105 includes the API(s) 114. The API(s) 114 may receive the group creation data 111 from the application 156 and the group manager 105 may update a data store 106, stored on the messaging platform 104, based on the group creation data 111. The data store 106 may store information about the groups 110 and the display columns 112 and information about which user accounts 108 are linked with which group 110 and/or which display column 112.

Referring to FIG. 1D, the data store 106 may link groups 110 to the user account 108a and link display columns 112 to the groups 110 associated with the user account 108a. For example, the data store 106 may define user-to-group relationships and column-to-group relationships. In response to receipt of the group creation data 111 for creating group 110a, the group manager 105 may update the data store 106 to associate the group 110a with the user account 108a. In other words, the group manager 105 may link the group 110a to the user account 108a. For example, the data store 106 may store one or more computer objects that identify the user account 108a and which group identifiers 128 are associated with the user account 108a.

In some examples, the data store 106 indicates a group order of the groups 110 associated with the user account 108a. For example, the group order may indicate an ordered sequence of group identifiers 128 that indicate an order of groups 110 provided by the group list 166. For example, the data store 106 may store, in association with the user account 108a, the group identifier 128 for the group 110a and the group identifier 128 for the group 110b. The group identifier 128 for the group 110a may indicate a location of the computer object associated with the group 110a. The group identifier 128 for the group 110b may indicate a location of the computer object associated with the group 110b.

In some examples, the group 110a is stored as one or more computer objects in the data store 106. The group 110a includes the group identifier 128 that uniquely identifies the group 110a, which is generated by the group manager 105. This group identifier 128 is used to link the group 110a to the user account 108a. The group identifier 128 may be a series of values (e.g., numbers, letters, and/or symbols) that can uniquely identify the group 110a. In some examples, the group identifier 128 is a URL pattern. The group 110a includes group attributes 129 that can define various attributes for the group 110a and column information 136 that identifies column identifiers 138 for the display columns 112 belonging to group 110a. The group identifier 128 is used to obtain the group attributes 129 and the column information 136.

The group attributes 129 may include a title 134 for the group 110a. In some examples, the group attributes 129 include a description for the group 11a. In some examples, the group attributes 129 include a sharing status 130 of the group 110a. If the sharing status 130 is a first value, the group 110a may be indicated as non-public (e.g., private) in which the display columns 112 of the group 110a can only be rendered on the computing device 152-1 associated with the user account 108a. In some examples, a single owner (or creator) is associated with a particular group 110. In some examples, there may be multiple owners (or creators) associated with a single group 110, where multiple users can collaborate to create a group 110.

If the sharing status 130 is a second value, the group 110a may be indicated as public (e.g., shareable). In some examples, if the sharing status 130 is the second value (e.g., public, shareable), the group attributes 129 may include a share group identifier 132, which is the identifier that is used to link to other user accounts 108 (e.g., user account 108b). In some examples, the group identifier 128 is linked to one or more user accounts 108 that have created the group 110. However, if the group 110a is shared, the share group identifier 138 (e.g., not the group identifier 128) is used to link to user accounts 108 that are following the shared group 110a. By using the share group identifier 138, the messaging system 100 may avoid duplicating computing resources for user accounts 108 that follow the shared group 110a. In some examples, certain types of display columns 112 may not be shareable, and if a group 110 has a display column 112 that is not allowed, the entire group 110 may be indicated as not shareable. In some examples, display columns 112 that include personalized results such as home timelines, direct messages, notifications, etc. may not be shareable.

In some examples, the share group identifier 132 is the resource locator identifier 107 that is included in the message 120a about the group 110a and/or included as part of the profile 172 of the user account 108a. In some examples, the share group identifier 132 is an identifier that points to the group identifier 128. In some examples, if the sharing status 130 is the first value (e.g., private), the share group identifier 132 is not provided or is blank.

The column information 136 may include column identifiers 138 for the display columns 112 that belong to the group 110a. A column identifier 138 may be generated by the group manager 105. A column identifier 138 may uniquely identify a computer object associated with a particular display column 112. In some examples, the column information 136 includes a column order 140 that specifies an order of the display columns 112. In some examples, the column order 140 is an ordered sequence of column identifiers 138, which corresponds to the order on how the display columns 112 are displayed on the user interface 164.

The display columns 112 are stored as one or more computer objects in the data store 106 and are linked to the groups 110. For example, as indicated above, the group 110a identifies column information 136, which includes the column identifiers 138 that belong to the group 110a. The column identifier 138 may reference a computer object associated with display column 112-1, which corresponds to one of the column identifiers 138 of the column information 136.

The display column 112-1 may include the column identifier 138 and column attributes 142. The column attributes 142 may include any of the attributes 155 described with reference to FIGS. 1B and 1C. Also, the column attributes 142 may include a sharing status 146 of the display column 112. For example, as indicated above, groups 110 may be shared, but, in some examples, individual display columns 112 may be shared. If the sharing status 146 is a first value, the display column 112-1 may be indicated as non-public (e.g., private) in which the display column 112-1 can only be rendered on the computing device 152-1 associated with the user account 108a. If the sharing status 146 is a second value, the display column 112-1 may be indicated as public (e.g., shareable). In some examples, if the sharing status 146 is the second value (e.g., public, shareable), the column attributes 142 include a share column identifier 148, which is the identifier that is used to link to other user accounts 108 (e.g., user account 108b). In some examples, the share column identifier 148 is the resource locator identifier 107 that is included in the message 120a about the display column 112-1 and/or included as part of the profile 172 of the user account 108a. In some examples, the share column identifier 148 is an identifier that points to the column identifier 138. In some examples, if the sharing status 146 is the first value (e.g., private), the share column identifier 148 is not provided or is blank.

Referring back to FIG. 1A, the group manager 105 may identify the user account 108a and use the user account 108a to obtain group list data 113 from the data store 106 and send the group list data 113 to the computing device 152-1 via the API(s) 114. For example, the group manager 105 may identify which groups 110 are associated with the user account 108a and the order of the groups 110 from the data store 106 and transmit the group list data 113 to the computing device 152-1. The application 156 may use the group list data 113 to render a group list 166 on the user interface 164, where the group list 166 provides a list of the groups 110 associated with the user account 108a according to the defined order. The group list 166 may identify the title 134 (and icon) associated with each group 110 and provide a selectable control to allow the user to select a particular group 110. In some examples, the group list 166 includes a description of a group 110.

In response to selection of a particular group 110 (e.g., group 110a), the application 156 may transmit a group selection request 115 to the group manager 105 via the API(s) 114. The group manager 105 may use the group identifier 128 of the selected group 110a to identify the display columns 112 associated with the group 110a (and their attributes 155) and send group data 117 to the computing device 152-1. The group data 117 may include information (and/or instructions) to render the display columns 112 of the group 110a on the user interface 164.

In some examples, the rendering of the multi-column display on the user interface 164 may cause an event producer system 178 to configure the search queries (as specified by the attributes 155 of the display columns 112) to match messages 120 from the message queue 118. The event producer system 178 is configured to support streaming search-query-results by matching queries against messages 120 of the message queue 118. In some examples, the search queries are received and stored at the event producer system 178 as query subscriptions (e.g., graphQL query subscriptions). GraphQL may specify three operation types such as query, mutation, and subscription. In some examples, the API(s) 114 includes a library (e.g., a GraphQL library) configured to support the subscription operations. The event producer system 178 may generate response events such that a response event is generated in response to a message 120 from the message queue 118 being determined as containing a query term of the query subscription. The event producer system 178 may publish the response events to a response event bus.

A transport engine 126 of the messaging platform 104 is configured to receive the response events from the response event bus and stream the messages 120 to the appropriate display columns 112 that are displayed on the user interface 164. In some examples, the transport engine 126 subscribes to the response event bus to receive the response events from the event producer system 178, generates (e.g., hydrates and applies visibility rules to) the messages 120 based on the response events (thereby obtaining messages 120 with the perspective of the user), and publishes the messages 120 on a delivery event bus for delivery to the application 156.

For example, when the group 110a is selected and then rendered on the user interface 164, the display columns 112 are rendered simultaneously on the user interface 164 (e.g., adjacent to each other). Each display column 112 displays messages 120 posted to a messaging platform that satisfy the attributes 155 and/or column type of a respective display column 112. When a display column 112 is displayed (e.g., visibly displayed) on the computing device, an active query (e.g., query subscription) is executed by the event producer system 178) in which messages 120 that satisfy the query subscriptions are streamed to the respective display column 112 so that a user can view a message 120 that has been posted to the messaging platform 104 in real-time or near real-time.

In some examples, the application 156 is configured to render a share control 168 on the user interface 164, which allows the user to share a group 110 or display column 112 with other users of the messaging platform 104. For example, in response to selection of the share control 168, the application 156 may transmit a share request 119 to the group manager 105 via the API(s) 114. The share request 119 may identify the group 110 (or display column 112) to be publicly shared. In response to the share request 119, the group manager 105 may update the data store 106. For example, if the group 110a is to be shared, the group manager 105 may update the sharing status 130 and provide a value for the share group identifier 132 in the group attributes 129. If the display column 112-1 is to be shared, the group manager 105 may update the sharing status 146 and provide a value for the share column identifier 148 in the group attributes 129.

In some examples, the group manager 105 may update the profile 172 of the user account 108a to provide information about the shared group 110a or shared display column 112-1. In some examples, the information about the shared group 110a or shared display column 112-1 includes a resource locator identifier 107, that when selected, renders a UI object that allows another user to link the shared group 110a or shared display column 112-1 to another user.

In some examples, the user may use the application 156 to transmit a message 120a about the shared group 110a or shared display column 112-1. For example, the user can post the message 120a to the messaging platform 104, which may transmit the message 120a to computing devices 152 associated with user accounts 108 that are linked to the user account 108a in the connection graph 124. In some examples, the user can send the message 120a as a direct message to one or more computing devices 152 associated with other user accounts 108.

A user may use the application 156a to view social media data of the messaging platform 104. For example, the social media data may include a home timeline of the user account 108b, direct messages associated with the user account 108b, and/or profile information of the users of the messaging platform 104 and/or other information provided by the messaging platform 104. The social media data may identify the message 120a posted to (or sent by) the computing device 152-1. As indicated above, the message 120a may identify a resource locator identifier 107, which, when selected by the user, renders a UI object that permits a user to follow the shared group 110a or shared display column 112-1.

In some examples, in response to receipt of a selection (e.g., follow section) taken with respect to the shared group 110a or shared display column 112-1, the computing device 152-1 may transmit a follow request 121 to the group manager 105 via the API(s) 114. Referring to FIG. 1E, in response to the follow request 121, the group manager 105 may update the data store 106 to associate the user account 108b with the shared group 110a or the shared display column 112-1. Referring to FIGS. 1D and 1E, the group manager 105 may obtain the share group identifier 132 from the group attributes 129 of the group 110a and link the share group identifier 132 to the user account 108b. The share group identifier 132 may be an identifier that points to the group identifier 128. In some examples, the group manager 105 may obtain the share column identifier 148 from the column attributes 142 of the display column 112-1 and link the share column identifier 148 to the user account 108b. The share column identifier 148 may be an identifier that points to the column identifier 138.

After the data store 106 is updated to link the user account 108b to the group 110a, the group 110a is available for selection by the user of the computing device 152-2. When selected by the user, the application 156a renders all the display columns 112 of the group 110a in the same manner that it can be rendered on the owner's device (e.g., computing device 152-1). In some examples, after the data store 106 is updated to link the user account 108b to the display column 112-1, the display column 112-1 is available for selection by the user of the computing device 152-2. When selected by the user, the application 156a renders the display column 112-1 in the same manner that it can be rendered on the owner's device (e.g., computing device 152-1).

Instead of using the group identifier 128 or the column identifier 138, the share group identifier 132 or the share column identifier 148 is used to link the group 110a or the display column 112-1 to the user account 108b. In this manner, the messaging platform 104 will avoid making duplicate copies of groups 110 or display columns 112 that are shared with other user accounts 108, which can reduce the amount of memory (and processing power) for sharing groups 110 and/or display columns 112.

In addition, these techniques will allow the owner (e.g., account 108a) of the group 110a to make changes to the group 110a (e.g., adding a display column 112, deleting a display column 112, changing one or more group attributes 129, changing one or more column attributes 142), and these changes will be propagated to all user accounts 108 (e.g., user account 108b) that are linked to or associated with the group 110a with the share group identifier 132 or the share column identifier 148. For example, since the user account 108b is linked to the share group identifier 132, which points to the group identifier 128, any changes that are made with respect to the group identifier 128 can be implemented on any follower accounts. Furthermore, with this data structure, the follower account (e.g., user account 108b) may not make changes to the group 110a (e.g., adding a display column 112, deleting a display column 112, changing one or more group attributes 129, changing one or more column attributes 142). Rather, the group 110a, when rendered on the computing device 152-2, can only be viewed by the user.

In some examples, a user of the computing device 152-2 can create their own version (e.g., group 110aa) of the shared group 110a or their own version (e.g., display column 112-11) of the shared display column 112-1 so that the user can make edits to the group 110aa or the display column 112-11. For example, referring to FIGS. 1A and 1E, the computing device 152-2 may transmit, over the network 150, a request 123 to the group manager 105 via the API(s) 114 to associate a group 110aa with the user account 108b, where the group 110aa is a duplicated copy of the group 110a. In some examples, the computing device 152-2 may transmit, over the network 150, a request 123 to the group manager 105 via the API(s) 114 to associate a display column 112-11 with the user account 108b, where the display column 112-11 is a duplicated copy of the display column 112-11.

In some examples, the request 123 is considered a request to generate a copy of the shared group 110a or the shared display column 112-1 and associate the copied version (e.g., group 110aa or display column 112-11) with the user account 108b so that the user account 108b is considered the owner of the group 110a or the display column 112-11. In some examples, the request 123 may be considered a request to create a localized version of the shared group 110a or the shared display column 112-1. In response to the request 123, the group manager 105 may generate the group 110aa by duplicating the information associated with the group 110a.

For example, the group manager 105 may duplicate the group 110a of FIG. 1D and any display columns 112 associated with the group 110a shown with respect to FIG. 1D (e.g., the group attributes 129, the column information 136, and the column attributes 142). In some examples, the group manager 105 may create a new group identifier 128 for the group 110aa and new column identifiers 138. The new group identifier 128 is associated with (or linked to) the user account 108b. If the request 123 relates to a shared display column 112-1, the group manager 105 may duplicate the display column 112-1 (e.g., the column attributes 142). In some examples, the group manager 105 may create a new column identifier 138 and associate the new column identifier 138 with the user account 108b. In this manner, the data store 106 can store another instance of the group 110a or the display column 112-1, and link the new instance (e.g., group 110aa or display column 112-11) to the user account 108b, where the user can make any changes to the group 110aa or the display column 112-11 (and then share the modified, duplicated group with other user accounts 108).

In some examples, referring to FIGS. 1A and 1F, the messaging platform 104 may include a store platform 125. The store platform 125 may be an online store that identifies groups 110 and/or display columns 112, which are available to users to follow or own. In some examples, the store platform 125 is a website (or section) of the messaging platform 104, where users can search and discover groups 110 and/or display columns 112 created by other user accounts 108 or by the messaging platform 104. In some examples, the store platform 125 may include a list of available groups 110 and/or a list of available display columns 112, where the user can select one or more of the groups 110 or display columns 112. In some examples, the list of available groups 110 and/or display columns 112 are indexed. In some examples, a user may publish (e.g., add) a group 110 and/or display column 112 to the store platform 125, which is then added to the index. In some examples, store platform 125 may include one or more crawlers configured to search the data store 106 and add groups 110 and/or display columns 112 having a sharing status (e.g., sharing status 130, sharing status 146) that is identified as shareable or public.

In some examples, the user can perform keyword searching to identify groups 110 or display columns 112 that the user would like to add to their user account 108. In some examples, the groups 110 and/or display columns 112 offered by the store platform 125 may be characterized by topics or subject matter. In some examples, the store platform 125 may be provide information about each group 110 and/or display column 112 such as the title 134 of the group 110, titles of any display columns 112 associated with a respective group 110, information about the owner of the group 110 or display column 112 (e.g., from the profile 172), and/or follower information (e.g., how many user accounts 108 have added a particular group 110 or display column 112 to their user account 108).

If a user follows a group 110 offered by the store platform 125, the group manager 105 may receive a follow request 121 and associate a share group identifier 132 of the requested group 110 with the following user account 108 in the data store 106 so that the group 110 can be rendered on that user's computing device (e.g., view only). Any changes made by the owner of the group 110 will be propagated to any of the follower user accounts 108. If a user requests a localized version of a group 110 offered by the store platform 125, the group manager 105 may receive a request 123, generate another instance of the group 110, and associate the instance of the group 110 with the user account 108 of the user. The user account 108 may be considered the owner of the new instance of the group 110 and can make any changes to their localized version.

In some examples, some of the groups 110 or display columns 112 offered by the store platform 125 may be available for purchase. In some examples, a group 110 or display column 112 may be available for users to follow (e.g., for free), but requires a purchase if a user would like to own a group 110 or display column 112 (so that the user can make edits). In some examples, a payment is requested if a user would like to follow a group 110 or display column 112 offered by the store platform 125.

In some examples, referring to FIGS. 1A and 1G, the messaging platform 104 may include a group suggestion unit 127 configured to identify group(s) 110 and/or display column(s) 112 as a recommendation 192 to a user account 108. In some examples, the recommendation 192 may be a recommendation to follow (or own) a certain group 110 or display column 112 created by another user account 108. For example, the group suggestion unit 127 may identify pre-created groups 110 and/or display columns 112 from the store platform 125 and/or the data store 106 and select one or more shared groups 110 or display columns 112 as a recommendation 192 to a user.

In some examples, the recommendation 192 may be a recommendation for a display column 112 to be added to a group 110 associated with a user account 108. For example, a user may begin to create a group 110 (e.g., titled “Milwaukee Bucks Basketball™”) and the group suggestion unit 127 may identify one or more attributes 155 (e.g., a potential search query, e.g., “Bobby Portis”) for a new display column 112 for the group 110. In some examples, the recommendation 192 may be a recommendation to create a new group 110 with one or more display columns 112.

The group suggestion unit 127 may include one or more machine-learning (ML) models 141 configured to identify information for a group 110 or display column 112 based on a plurality of signals. In some examples, the ML models 141 include a neural network. The group suggestion unit 127 may receive a wide variety of signals such as user account information 180 for a particular user account 108. The user account information 180 may include identification of interest(s) 182 and/or topic(s) 184 that the user has selected. In some examples, the user can select one or more interests 182 (e.g., predefined interests), and these interests 182 are stored in the user account 108 of the user. In some examples, the user may be able to select certain topics 184 to follow, and these topics 184 are stored in the user account 108 of the user. The signals may include information from the connection graph 124 such as which user accounts 108 are connected to the user account 108 and the group suggestion unit 127 may use the user account information 180 from the connected user accounts 108 and/or information that was posted by the connected user accounts 108. The signals may include user engagement 186 of the user account 108 such as which messages the user has liked, favoritized, and/or re-shared. The signals may include information from the data store 106 such as which groups 110 or display columns 112 have been created by the user account 108 and/or created by other user accounts 108. The signals may include trending data 188 such as trending entities 190 and/or trending topics 184a.

A ML model 141 is a predictive model. In some examples, a ML model 141 includes a neural network. The ML model 141 may be an interconnected group of nodes, each node representing an artificial neuron. The nodes are connected to each other in layers, with the output of one layer becoming the input of a next layer. The ML model 141 transforms an input, received by the input layer, transforms it through a series of hidden layers, and produces an output via the output layer. Each layer is made up of a subset of the set of nodes. The nodes in hidden layers are fully connected to all nodes in the previous layer and provide their output to all nodes in the next layer. The nodes in a single layer function independently of each other (i.e., do not share connections). Nodes in the output provide the transformed input to the requesting process. In some examples, the ML model 141 is a convolutional neural network, which is a neural network that is not fully connected. Convolutional neural networks therefore have less complexity than fully connected neural networks. Convolutional neural networks can also make use of pooling or max-pooling to reduce the dimensionality (and hence complexity) of the data that flows through the neural network and thus this can reduce the level of computation required. This makes computation of the output in a convolutional neural network faster than in neural networks.

The ML model 141 includes a set of computational processes for receiving a set of inputs (e.g., input values) and generating one or more outputs (e.g., output values). In some examples, the output value(s) may represent whether the content includes restricted content. The plurality of layers may include an input layer, one or more hidden layers, and an output layer. In some examples, one or more of the outputs the output layer represents a possible prediction (e.g., the recommendation 192). In some examples, the output of the output layer with the highest value represents the prediction.

In some examples, the ML model 141 is a deep neural network (DNN). For example, a deep neural network (DNN) may have one or more hidden layers disposed between the input layer and the output layer. However, the ML model 141 may be any type of artificial neural network (ANN) including a convolution neural network (CNN). The neurons in one layer are connected to the neurons in another layer via synapses. Each synapse is associated with a weight. A weight is a parameter within the ML model 141 that transforms input data within the hidden layers. As an input enters the neuron, the input is multiplied by a weight value and the resulting output is either observed or passed to the next layer in the ML model 141. For example, each neuron has a value corresponding to the neuron's activity (e.g., activation value). The activation value can be, for example, a value between 0 and 1 or a value between −1 and +1. The value for each neuron is determined by the collection of synapses that couple each neuron to other neurons in a previous layer. The value for a given neuron is related to an accumulated, weighted sum of all neurons in a previous layer. In other words, the value of each neuron in a first layer is multiplied by a corresponding weight and these values are summed together to compute the activation value of a neuron in a second layer. Additionally, a bias may be added to the sum to adjust an overall activity of a neuron. Further, the sum including the bias may be applied to an activation function, which maps the sum to a range (e.g., zero to 1). Possible activation functions may include (but are not limited to) rectified linear unit (ReLu), sigmoid, or hyperbolic tangent (TanH).

The computing device 152-2 may be an example of the computing device 152-1 and may include any of the features discussed with reference to the computing device 152-1. The computing device 152-1 may be any type of computing device that includes one or more processors 153, one or more memory devices 151, a display 162, and an operating system 154 configured to execute (or assist with executing) one or more applications 156. In some examples, the computing device 152-1 is a laptop or desktop computer. In some examples, the computing device 152-1 is a tablet computer. In some examples, the computing device 152-1 is a smartphone. In some examples, the computing device 152-1 is a wearable device. The display 162 is the display of the computing device 152-1. The display 162 may also include one or more external monitors that are connected to the computing device 152-1. The operating system 154 is a system software that manages computer hardware, software resources, and provides common services for computing programs. In some examples, the operating system 154 is an operating system designed for a larger display 162 such as a laptop or desktop (e.g., sometimes referred to as a desktop operating system). In some examples, the operating system 154 is an operating system for a smaller display 162 such as a tablet or a smartphone (e.g., sometimes referred to as a mobile operating system).

The processor(s) 153 may be formed in a substrate configured to execute one or more machine executable instructions or pieces of software, firmware, or a combination thereof. The processor(s) 153 can be semiconductor-based—that is, the processors can include semiconductor material that can perform digital logic. The memory device(s) 151 may include a main memory that stores information in a format that can be read and/or executed by the processor(s) 153. The memory device(s) 151 may store applications (e.g., the applications 156, the operating system 154) etc.) that, when executed by the one or more processors 153, perform certain operations.

The server computer(s) 102 may be computing devices that take the form of a number of different devices, for example a standard server, a group of such servers, or a rack server system. In some examples, the server computer(s) 102 may be a single system sharing components such as processors and memories. In some examples, the server computer(s) 102 may be multiple systems that do not share processors and memories. The network 150 may include the Internet and/or other types of data networks, such as a local area network (LAN), a wide area network (WAN), a cellular network, satellite network, or other types of data networks. The network 150 may also include any number of computing devices (e.g., computer, servers, routers, network switches, etc.) that are configured to receive and/or transmit data within network 150. Network 150 may further include any number of hardwired and/or wireless connections.

The server computer(s) 102 may include one or more processors 101 formed in a substrate, an operating system (not shown) and one or more memory devices 103. The memory devices 103 may represent any kind of (or multiple kinds of) memory (e.g., RAM, flash, cache, disk, tape, etc.). In some examples (not shown), the memory devices 103 may include external storage, e.g., memory physically remote from but accessible by the server computer(s) 102. The memory device(s) 103 may store the data store 106, the message query 118, the conversation graph 122, the connection graph 124 and one or more modules (e.g., API(s) 114, group manager 105, event producer system 178, store platform 125, group suggestion unit 127, transport engine 126, etc.) representing specially programmed software. The memory device(s) 103 may store executable instructions that when executed by one or more processors 101 cause the one or more processors 101 to execute the operations described with reference to the messaging platform 104 and/or any of the modules of the messaging platform 104.

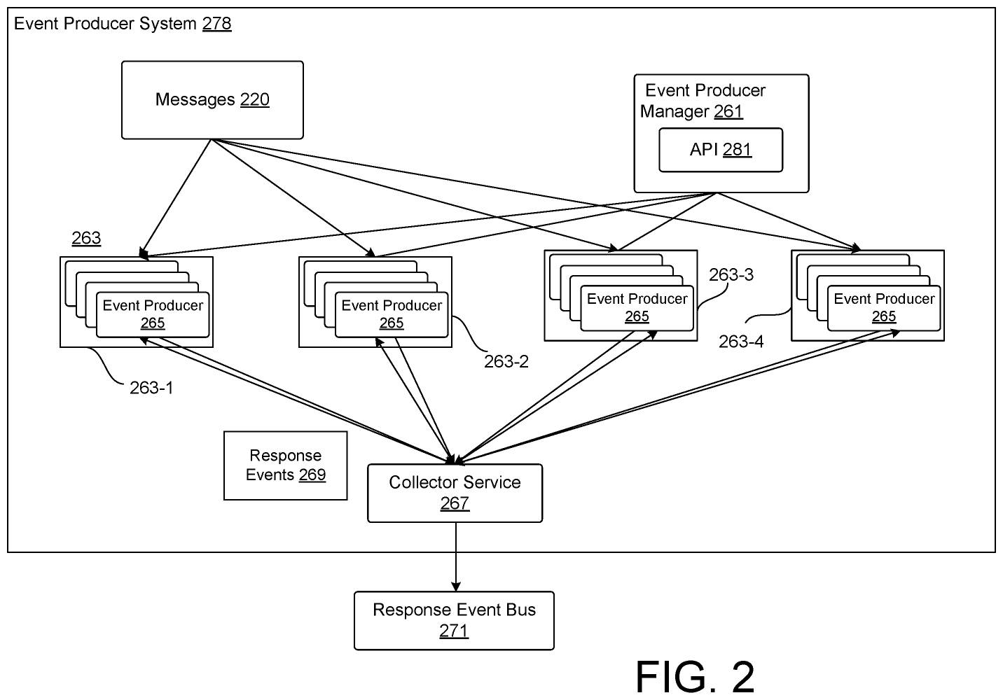

FIG. 2 illustrates an example of an event producer system 278 according to an aspect. The event producer system 278 may be an example of the event producer system 178 of FIGS. 1A through 1G. The event producer system 278 includes an event producer manager 261, event producers 265 communicatively connected to the event producer manager 261, and a collector service 267 communicatively connected to the event producers 265. The event producer manager 261 may obtain query subscriptions related to the groups (e.g., groups 110 of FIGS. 1A through 1G) and display columns and configures the event producers 265 to match content from messages 220 of a message queue (e.g., the message queue 118 of FIG. 1A) according to the criteria of the query subscriptions. In some examples, a query subscription is a GraphQL query subscription. In some examples, the event producer manager 261 includes an API 281 configured to receive a query subscription via a thrift request.

In some examples, the event producers 265 are arranged in event producer groups 263 to execute a relatively large number of query subscriptions against the message queue. For example, the event producer system 278 may include a plurality of event producer groups 263 such as a first event producer group 263-1, a second event producer group 263-2, a third event producer group 263-3, and a fourth event producer group 263-4. Although four event producer groups 263 are illustrated in FIG. 2, the event producer groups 263 may include any number of event producer groups 263. In some examples, each event producer group 263 is configured to separately receive the messages 220 from the message queue (e.g., separately receive the full message queue). In other words, each event producer group 263 is configured to independently monitor the message queue. Each event producer group 263 includes a plurality of event producers 265.

Each event producer 265 within a respective event producer group 263 may receive a separate portion of the messages 220 from the message queue. For example, the message queue is divided (e.g., equally divided or unequally divided) among the event producers 265 within a particular event producer group 263. For example, if there are four event producers 265 within the first event producer group 263-1, a first event producer receives a first portion of the messages 220, a second event producer receives a second portion of the messages 220, a third event producer receives a third portion of the messages 220, and a fourth event producer receives a fourth portion of the messages 220, where the first through fourth portions cover the entire message queue.

Each event producer group 263 is allocated a portion of the query subscriptions. For example, if there are one hundred query subscriptions, twenty-five query subscriptions may be allocated to the first event producer group 263-1, twenty-five query subscriptions may be allocated to the second event producer group 263-2, twenty-five query subscriptions may be allocated to the third event producer group 263-3, and twenty-five query subscriptions may be allocated to the fourth event producer group 263-4. However, it is noted that the number of query subscriptions may be in the thousands or millions.

The event producer manager 261 may receive the query subscription and assign the query subscription to at least one of the event producer groups 263. In some examples, the event producer manager 261 assigns the query subscription to two event producer groups 263, e.g., a primary event producer group and a second event producer group. In some examples, the event producer manager 261 is configured to monitor the number of query subscriptions being assigned and executed for each event producer group 263 and configured to increase and/or decrease the number of event producer groups 263 and/or the number of event producers 265 within each event producer group 263. For instance, in response to the number of event producers 265 in a particular event producer group 263 being increased, each individual event producer 265 may receive fewer messages from the message queue to process and consequently may have more computational capacity to handle extra searches. In response to the number of event producer groups 263 being increased, the number of search terms allocated to the event producer 265 may be reduced.

Each event producer 265 is configured to generate a response event 269 in response to the query subscription being matched against a message from the respective portion of the messages 220. As shown with respect to the previous figures, each response event 269 includes a message identifier and subscription data providing information about the query subscription.

The collector service 267 is configured to receive the response events 269 from the event producers 265 and publish the response events 269 to a response event bus 271. In some examples, the collector service 267 may determine whether the message identified by the response event has already been published to the response event bus 271, and then discard the response event 269 in response to the message being determined as already been published to the response event bus 271 to avoid the duplication of messages sent to the client application. In some examples, the collector service 267 may determine whether a number of response events 269 within a period of time (e.g., one second) has exceeded a streaming rate threshold, and discard one or more response events 269 (e.g., not publish one or more response events 269 on the response event bus 271). Also, the collector service 267 is configured to receive status responses from the event producers 265 and periodically send a status message (e.g., fail, ok, and/or renew) by publishing the status message on the response event bus 271. If the status message indicates an error, the client application may be required to transmit the query subscription request and the subscribe request to re-start the query subscription.

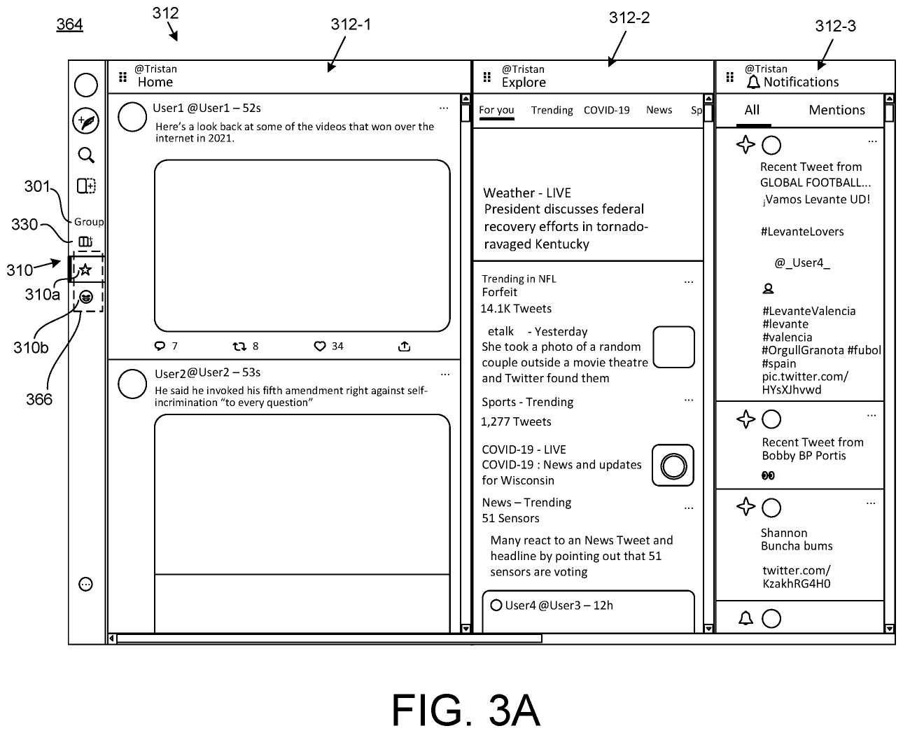

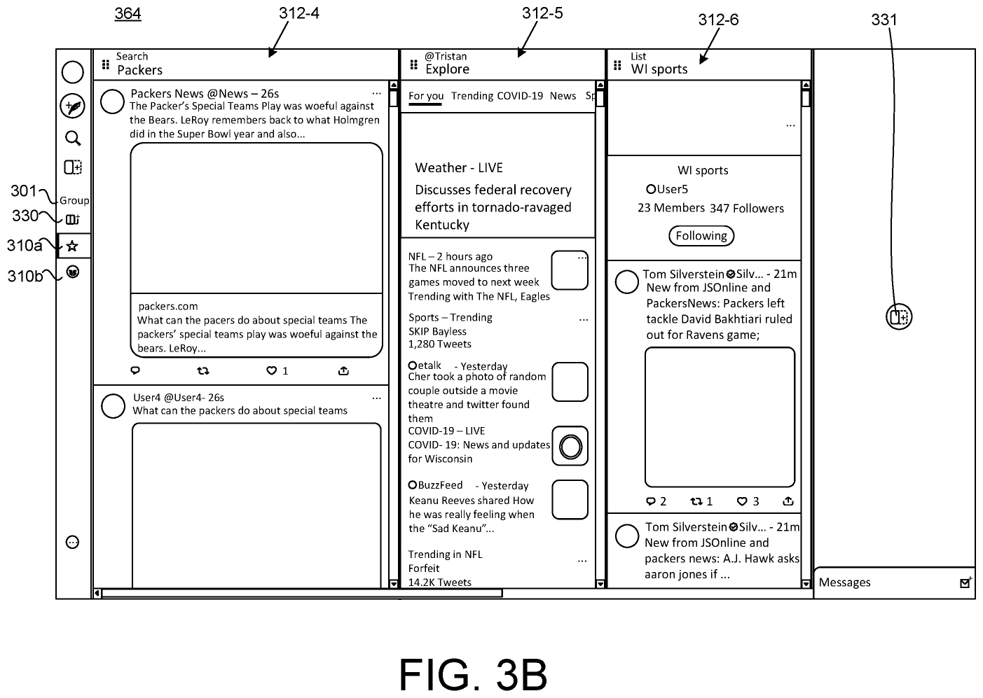

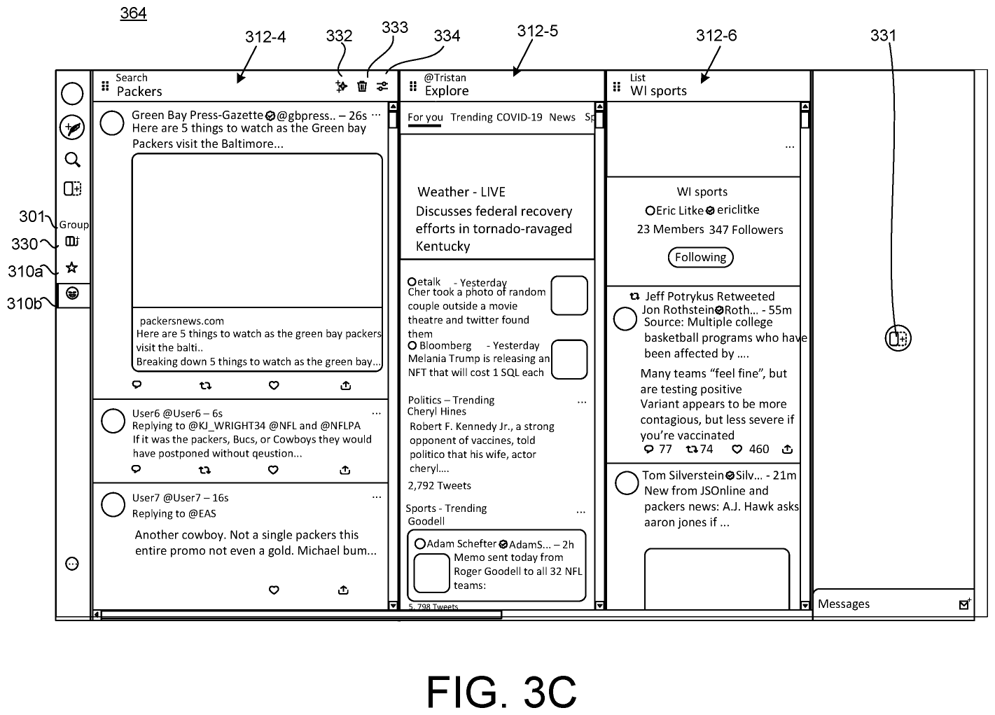

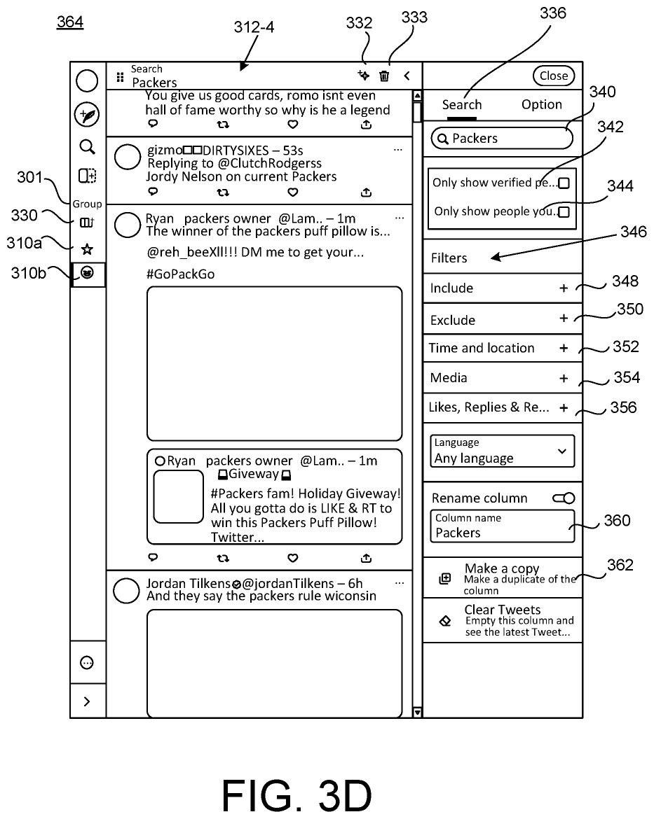

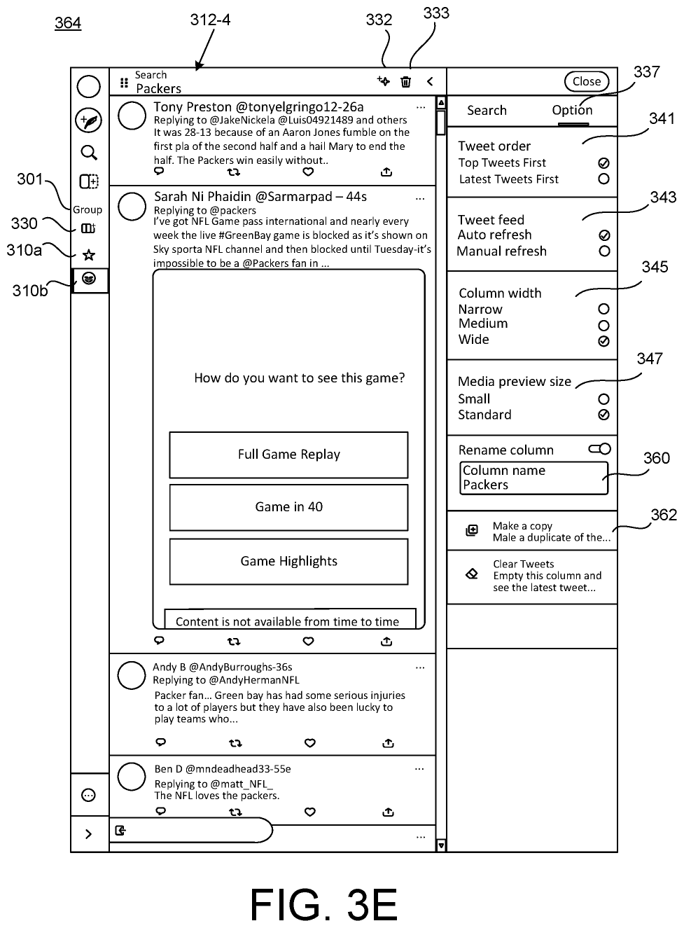

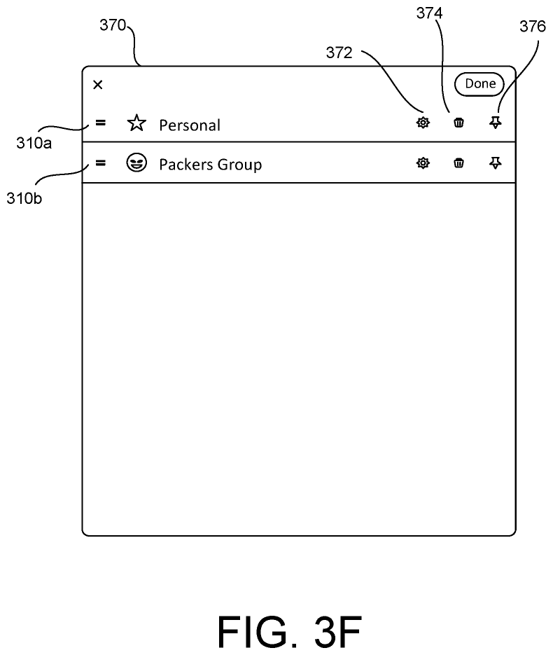

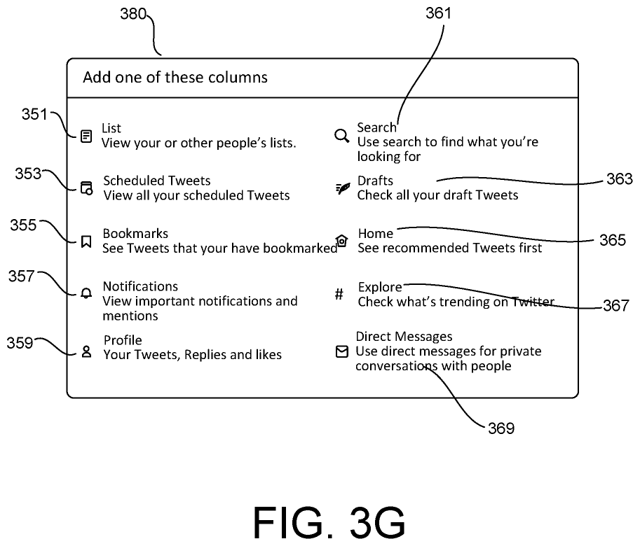

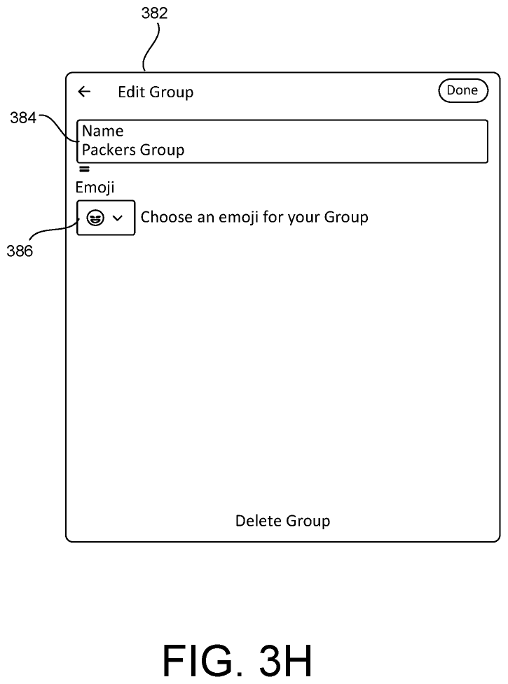

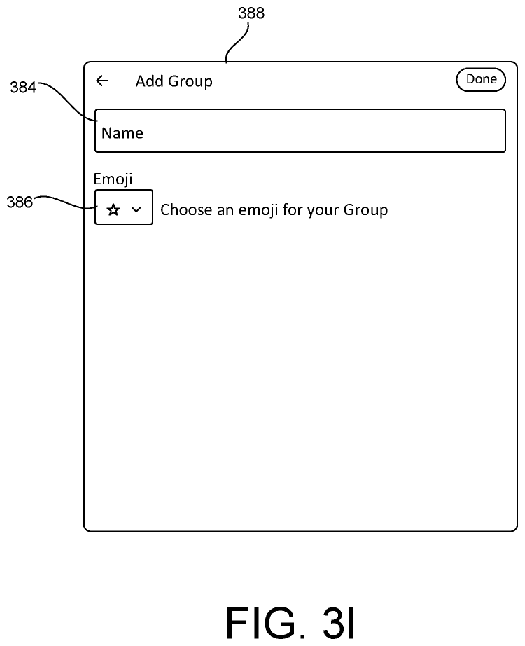

FIGS. 3A through 3I illustrate example user interfaces 364 of a client application configured to communicate with a messaging platform to create and render groups 310 according to various aspects. The user interfaces 364 of FIGS. 3A through 3I may be examples of the user interface 164 of FIGS. 1A through 1G. As shown in FIG. 3A, the user interface 364 displays a group 310a associated with a first user account, where the group 310a includes a display arrangement (e.g., a multi-column layout) of a display column 312-1, a display column 312-2, and a display column 312-3. The user interface 364 also displays a group list 366 (e.g., the group list 166 of FIG. 1A). The group list 366 identifies any groups 310 associated with the first user account. In some examples, the group list 366 provides an icon that can identify a particular group 310. In some examples, the group list 366 provides a title of each group 310. The group list 366 includes a group 310a and a group 310b. A user may select the group 310a from the group list 366, which causes the client application to render the display columns 312 associated with the group 310a, as shown in FIG. 3A.

The display column 312-1 displays a home timeline of the user. The home timeline displays messages from user accounts that are connected to the first user account. The display column 312-2 displays an explore timeline of the user. The explore timeline may include information collected by the messaging platform such as personalized social media data and data identified as trending on the messaging platform. The display column 312-3 displays a notification timeline of the user. The notification timeline displays notification messages of the user.

The user interface 364 may include a group creation option 301, which, when selected, renders a UI object 388 (as shown in FIG. 3I) to permit the user to create a new group 310. Referring to FIG. 3I, the UI object 388 may define a text entry field 384 that allows the user to enter a title for the new group 310. In some examples, the UI object 388 may include an icon selection option 386 that allows the user to identify an icon for the new group 310a.

Referring back to FIG. 3A, the user interface 364 may include a group management control 330, which, when selected, renders a UI object 370 (as shown in FIG. 3F) to view the groups 310 associated with the first user account and to edit group attributes (e.g., edit title, change icon, delete group, etc.) of a group 310. Referring to FIG. 3F, the UI object 370 may display a list of the groups 310 associated with the first user account, e.g., group 310a and group 310b. Also, the UI object 370 may provide a plurality of controls that allows the user to manage the groups 310. For example, the UI object 370 may include a delete option 374, which, when selected by the user, causes the deletion of a respective group.

The UI object 370 may include a pin control 376, which, when selected by the user, causes a respective group 310 to be included in the group list 366 (e.g., an unpinned group may be associated the first user account but not identified as part of the group list 366). In some examples, the UI object 370 may include an edit group control 372, which, when selected by the user, renders a UI object 382 (as shown in FIG. 3H) to allow the user to edit attributes of the group. As shown in FIG. 3H, the UI object 382 includes a text entry field 384 to allow the user to rename the title, and an icon selection option 386 to allow the user to re-select an icon for the group.

A user may select the group 310b from the group list 366, which causes the client application to render the display columns 312 associated with the group 310b, as shown in FIG. 3B. For example, the group 310b includes a display column 312-4, a display column 312-5, and a display column 312-6. The display column 312-4 displays a search timeline in which messages that have the term “packers” are displayed. The display column 312-5 is an explore timeline of the user. The explore timeline may include information collected by the messaging platform such as personalized social media data and data identified as trending on the messaging platform. The display column 312-6 is a list timeline titled “WI Sports.” The WI Sports list may be a collection of user accounts (curated by the messaging platform) that typically post messages about WI sports. The list timeline displays messages posted from user accounts associated with the curated list.

Referring to FIG. 3B, the user interface 364 includes a new column control 331, which, when selected by the user, causes the application to render UI object 380 (in FIG. 3G) to enable the user to add a display column 312 to the group 310b. Referring to FIG. 3G, the UI object 380 may allow the user to select a column type (e.g., the column type 131 of FIG. 1B) for a display column.

The column type may be a list timeline 351 that renders messages from a predefined list of user accounts associated with a particular topic (e.g., “WI Sports”). The column type may be a scheduled message timeline 353 that renders messages, associated with the first user account, that are scheduled to be posted to the messaging platform. The column type may be a bookmark timeline 355 that renders messages that the user has bookmarked. The column type may be a notification timeline 357 that renders notification messages associated with the first user account. The column type may be a profile timeline 359 that renders messages from the profile of the first user account. The column type may be a search timeline 361 that renders messages from the message queue that contain or more search terms entered by a user. The column type may be a draft timeline 363 that renders draft messages (e.g., drafted but not posted) associated with the first user account. The column type may be a home timeline 365 that renders messages from the home timeline of the user account. The column type may be an explore timeline 367 that renders information that identifies trending entities, hashtags, and/or user accounts on the messaging platform. The column type may be a direct message timeline 369 that renders messages sent directly to the first user account.

Referring to FIG. 3C, the user interface 364 may include controls to manage a particular display column 312. For example, the user interface 364 may have a message order control 332 that allows the user to select a message order of display column 312-4 (e.g., top messages first, latest messages first, etc.). The user interface 364 may include a delete control 333, which, when selected, causes the application to delete the display column 312-4. The user interface 364 may include an attribute control 334, which, when selected, causes the application to adjust the attributes (e.g., the attributes 155 of FIGS. 1A through 1G) of the display column 312-4, as shown on FIG. 3D.

Referring to FIG. 3D, the user interface 364 may include a search tab 336 that allows the user to set or adjust one or more search filters associated with display column 312-4, which may be stored as column attributes 142 and/or attributes 155. For example, the search tab 336 may include a search field 340 that allows the user to enter/adjust one or more search terms that are used to match messages exchanged on the messaging platform. The search tab 336 may include an option 342 to display messages from verified user accounts and an option 344 to display messages from user accounts that are connected to the first user account. The search tab 336 may include a filter section 346 that can define filter parameters (e.g., the filter parameters 157 of FIGS. 1A through 1G).

In some examples, the filter section 346 includes one or more expandable sections that may be expanded to enter filter parameters. For example, the filter section 346 may include an include section 348 to allow the user to enter one or more search terms to be included within the messages, an exclude section 350 to allow the user to enter one or more one or more search terms to be excluded from the messages, and a time and location section 352 to allow the user to define a certain time frame and/or location for the messages that are rendered in the display column 312-4. The filter section 346 may include a media section 354 to allow the user to select whether messages with media (e.g., video, images, audio, etc.) are only displayed (e.g., messages not having media are filtered out). The filter section 346 may include an engagement section 356 to allow the user to specify whether the messages rendered in the display column can be new messages, replies, re-shares, and/or favoritized messages. The search tab 336 may include a text entry field 360 that allows the user to define a title for the display column 312-4, a copy option 362, which, when selected, generates a copy of the display column 312-4, and an option to allow the user to clear (e.g., empty) the contents of the display column 312-4.

Referring to FIG. 3E, the user interface 364 may include an option tab 337 that permits the user to set or adjust display parameters (e.g., the display parameters 159 of FIGS. 1A through 1G). For example, the option tab 337 includes a message order option 341 that allows the user to select an order of the messages displayed by the display column 312-4 (e.g., top message first, latest messages first, etc.). The option tab 337 includes a message feed option 343 that allows the user to specify how the messages are refreshed on the display column 312-4 (e.g., auto refresh, or manual refresh). If the auto refresh selection is enabled, as soon as a message is identified as meeting the attributes of the display column, the message is pushed to the user interface (e.g., without the user hitting refresh). The option tab 337 includes a display dimension option 345 that allows the user to specify a dimension (e.g., width, size, or, in some examples, length) of the display column 312-4, and a media preview size option 347 that allows the user to specify the size of media (e.g., images, video) contained within the messages of the display column 312-4. In some examples, the option tab 337 may include a text entry field 360 that allows the user to define a title for the display column 312-4, a copy option 362, which, when selected, generates a copy of the display column 312-4, and an option to allow the user to clear (e.g., empty) the contents of the display column 312-4.

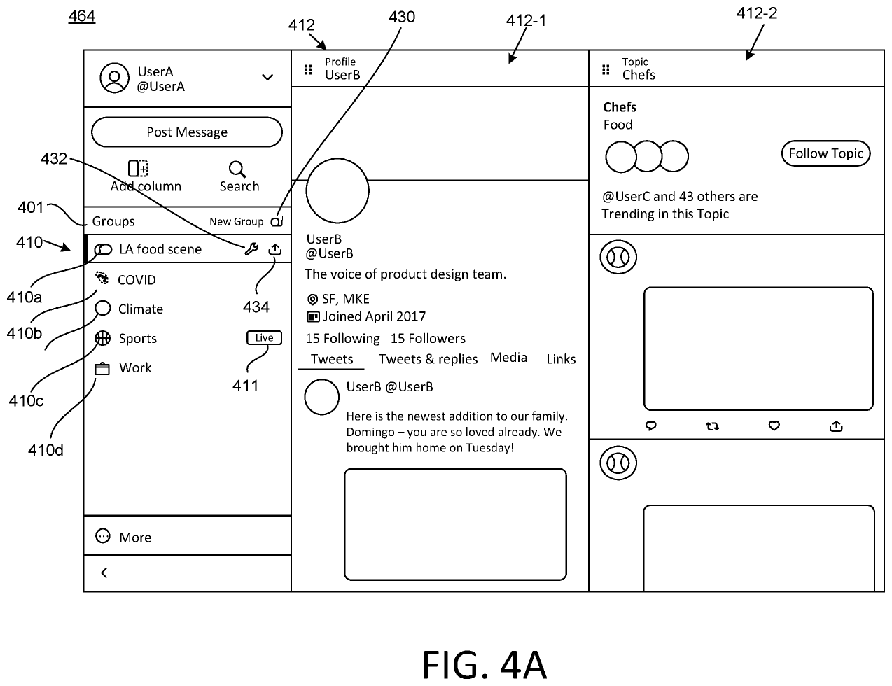

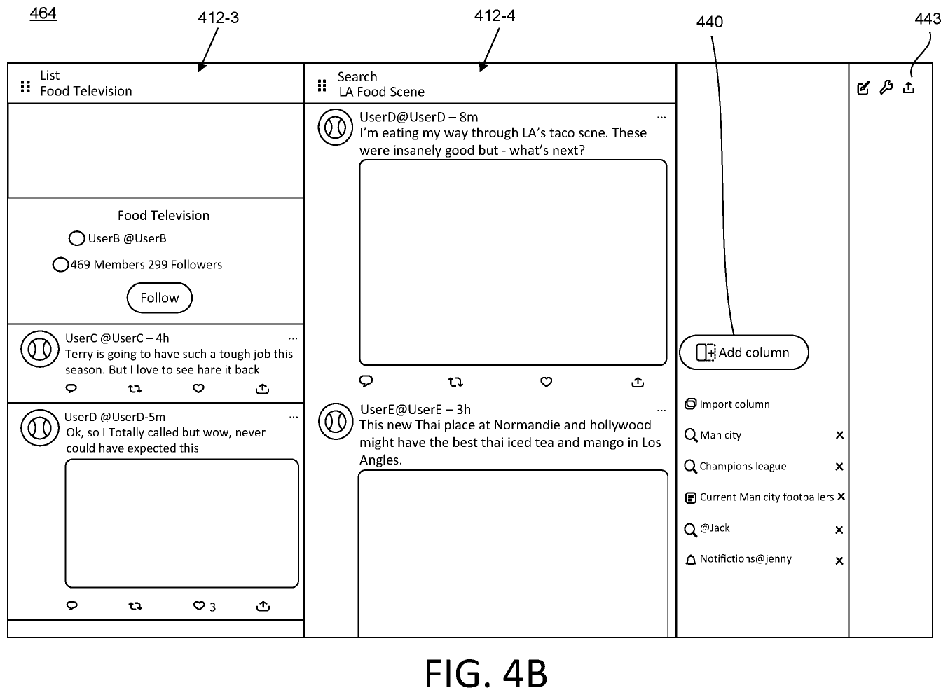

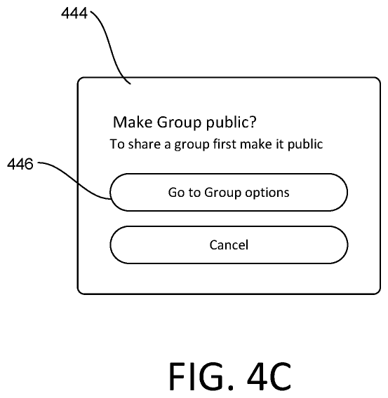

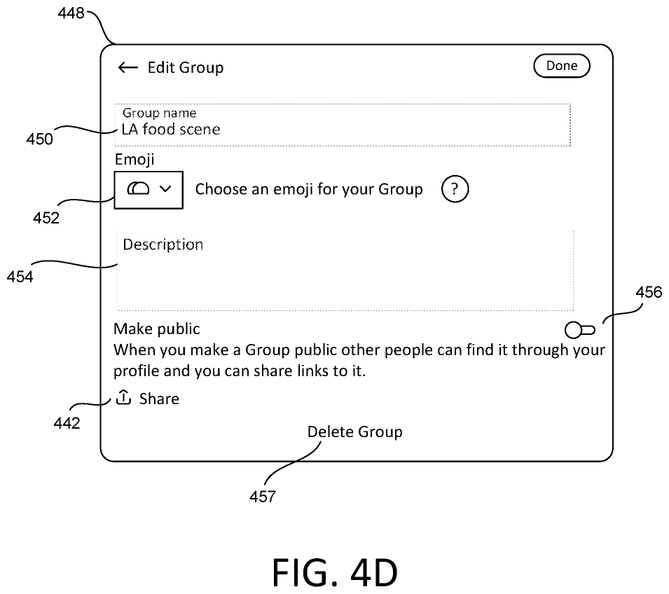

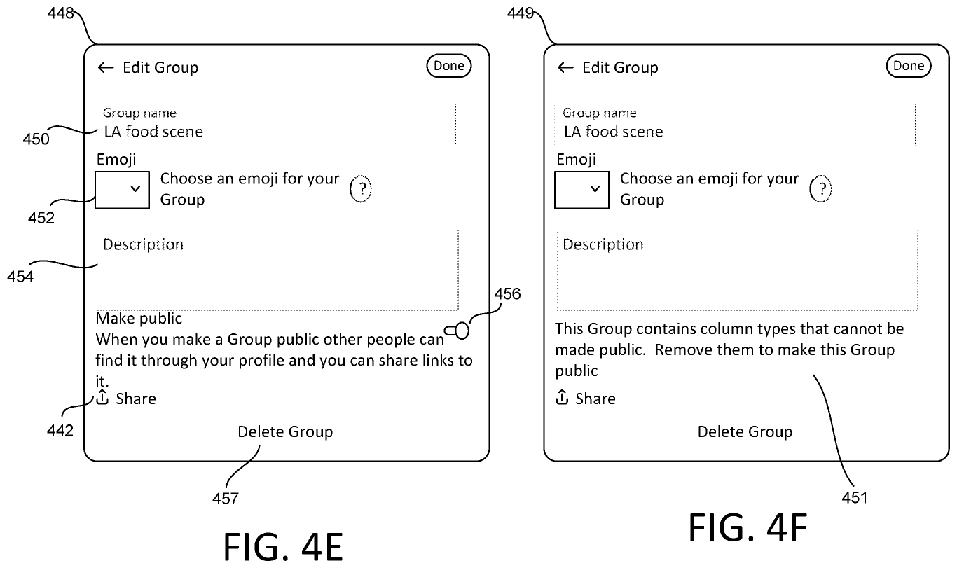

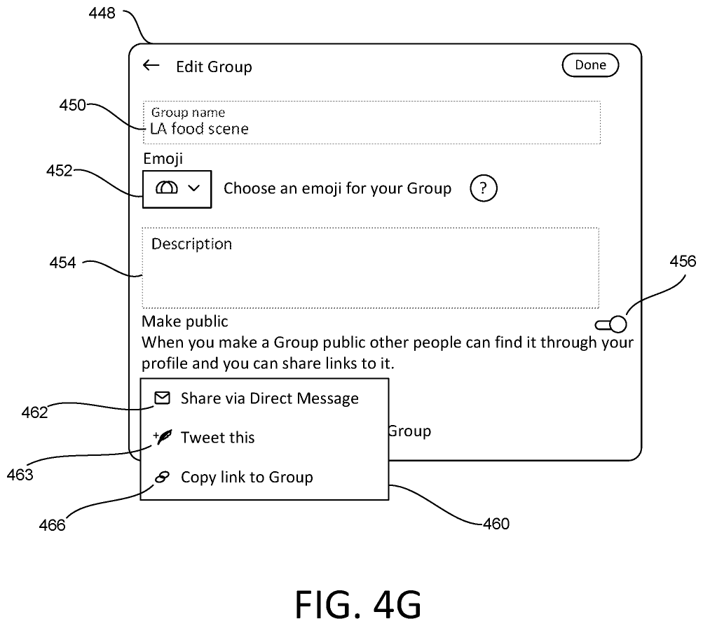

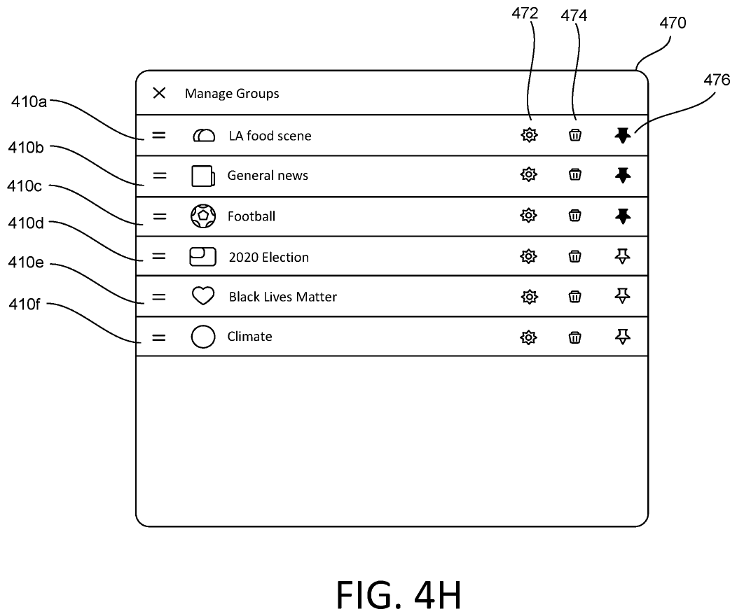

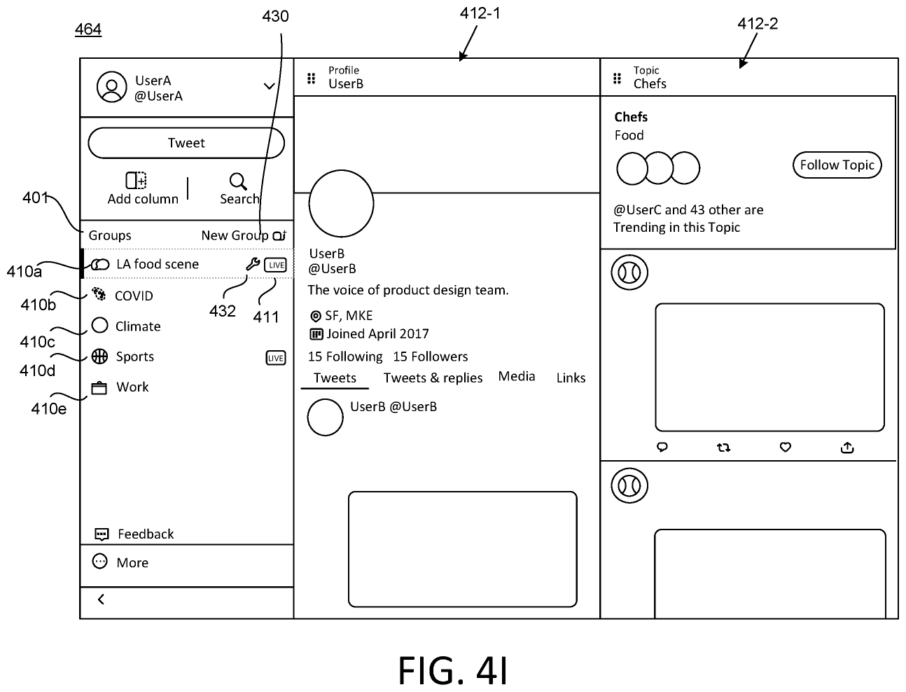

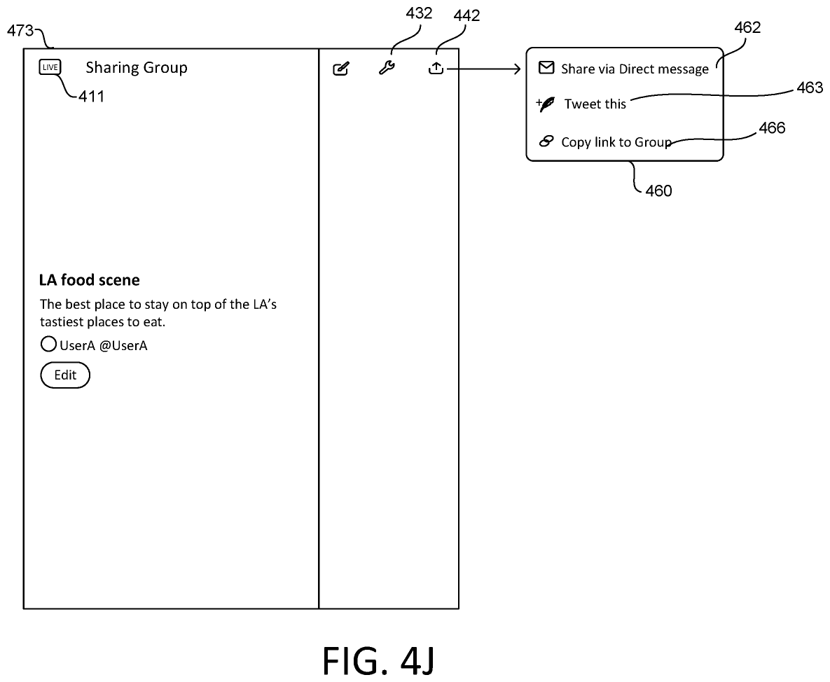

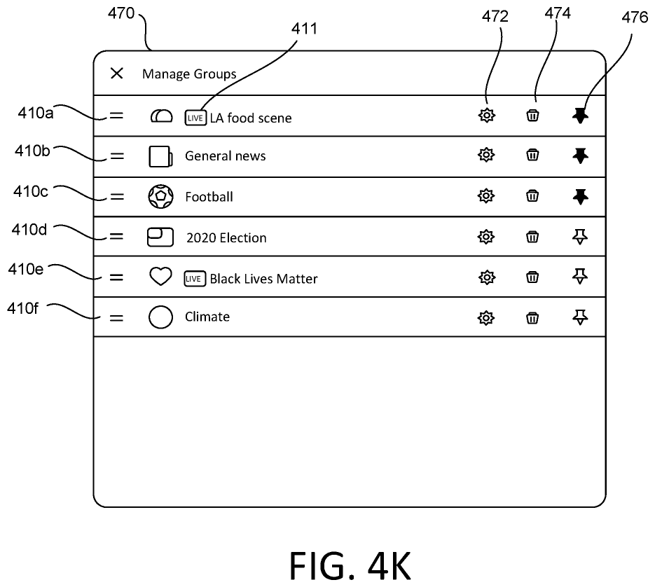

FIGS. 4A through 4K illustrate example user interfaces 464 for sharing a group 410 on a messaging platform according to various aspects. The user interfaces 464 may be examples of the user interface 164 of FIGS. 1A through 1G and may include any of the details discussed with reference to those figures.

As shown in FIG. 4A, the user interface 464 displays a group 410a associated with a first user account, where the group 410a includes a display arrangement (e.g., a multi-column layout) of a display column 412-1 (as shown on FIG. 4A), a display column 412-2 (as shown on FIG. 4A), a display column 412-3 (as shown on FIG. 4B), and a display column 412-4 (as shown on FIG. 4B). Also, the user interface 464 includes a control 440 (as shown on FIG. 4B) to add a display column 412 to the group 410a. In some examples, the user interface 464 may include a column share control 443, which, when selected by the user, causes a display column 412 to be shared. The user interface 464 of FIGS. 4A and 4B may be a single interface that simultaneously displays the display column 412-1, the display column 412-2, the display column 412-3, and the display column 412-4 on the same display screen.

The user interface 464 also displays a group list (e.g., the group list 166 of FIG. 1A). The group list identifies any groups 410 associated with the first user account. In some examples, the group list provides an icon that can identify a particular group 410. In some examples, the group list provides a title (e.g., LA food scene, COVID, Climate, Sports, Work) of each group 410. The group list includes a group 410a (LA food scene), a group 410b (Climate), a group 410c (Sports), and a group 410d (Work). A user may select the group 410a from the group list, which causes the client application to render the display columns 412 associated with the group 410a, as shown in FIGS. 4A and 4B.

The user interface 464 includes a group share control 434 that permits the user to share a group 410 from the group list. In response to selection of the group share control 434, in some examples, the application may render a UI object 444 that provides a configuration dialog asking whether or not to make the group 410a public, as shown in FIG. 4C. In some examples, the application may render the UI object 444 when the group 410a is currently not public (e.g., the group 410a is set to private). In some examples, if the group 410a is already public, the application may render a UI object 460 (as shown in FIG. 4J) that provides various sharing options such as a first sharing option 462 for sending a direct message, a second sharing option 463 for posting a message to the messaging platform, and a third sharing option 466 for copy a link (e.g., the resource locator identifier 107 of FIG. 1A), which can be shared outside the messaging platform.

The UI object 444 may include a selectable link 446, which, when selected by the user, renders a UI object 448 to edit one or more group attributes (e.g., the group attributes 129 of FIGS. 1A through 1G) associated with the group 410a, as shown in FIGS. 4D and 4E. In FIGS. 4D and 4E, the UI object 448 includes a text entry field 450 to edit the title of the group 410a, an icon selection option 452 to allow the user to select an icon for the group 410a, a text entry field 454 that allows the user to enter a description of the group 410a. The UI object 448 may also include a public option 456 that allows the user to set the group 410a to public. In some examples, the public option 456 is a toggle switch. In FIG. 4D, the public option 456 is set to private. In FIG. 4E, the public option 456 is set to public. Also, the UI object 448 includes a group share control 442 that, after the group 410a is set to public, allows the user to share the group 110a within (and outside of) the messaging platform. In some examples, when the public option 456 is set to private, the group share control 442 on FIG. 4D is deactivated (e.g., cannot be selected). However, when the public option 456 is set to public, the group share control 442 on FIG. 4E is activated (e.g., can be selected). Also, the UI object 448 may include a delete option 457 that allows the user to delete the group 410a.

In some examples, the group 410a may include one or more display columns 412 that cannot be made public. In some examples, display columns 412 relating to search timelines or list timelines can be made public. In some examples, a display column 112 relating to a user's home timeline cannot be made public. In some examples, a display column 112 relating to one or more of a scheduled message timeline, a notification timeline, a direct message timeline, an explore timeline, a draft message timeline, and/or a profile timeline cannot be made public.

In some examples, the determination of whether a group 410a can or cannot be made public is based on the column types of the display columns 412 associated with a particular group 410a. In some examples, a group manager (e.g., the group manager of FIG. 1A) obtains the column types from the data store (e.g., the data store 106 of FIG. 1A) and determines whether the group 410a can or cannot be made public. In some examples, if the group 410a includes a column type other than a search timeline or a list timeline, the group 410a cannot be made public. In some examples, if the group 410a cannot be made public, the application may render a UI object 449, as shown in FIG. 4F, on the user interface of the application. The UI object 449 may be similar to the UI object 448 of FIGS. 4C, 4D, and 4G except that the UI object 449 does not include the public option 456. Also, the UI object 449 may include a notification 451 that the group 410a includes at least one display column 412 that cannot be made public.

In response to selection of the group share control 442 on FIG. 4E, the application may render a UI object 460 that provides sharing options for sharing the group 410a, as shown in FIG. 4G. The sharing options may include a first sharing option 462 for sending a direct message to one or more user accounts of the messaging platform, a second sharing option 463 for posting a message to the messaging platform (thereby transmitting a message to each user account connected to the first user account), and a third sharing option 466 for copying a link (e.g., the resource locator identifier 107 of FIG. 1A), which can be shared within or outside the messaging platform. In some examples, the link is a uniform resource locator (URL) that points to a web resource on the Internet. The link can be shared outside the messaging platform by transmitting the link through a variety of operations, such as copying/pasting the link, emailing the link, texting the link, saving the link to a storage system, transmitting the link to other social media platforms, etc.

Referring back to FIG. 4A, the user interface 464 may include a group creation control 430, which, when selected, renders a UI object (e.g., the UI object 388 of FIG. 3I) to permit the user to create a new group 410. In some examples, the user interface 464 includes a selectable link 432 to the group edit control, e.g., UI object 448 or UI object 449. For example, in response to selection to the selectable link 432, the UI object 448 or the UI object 449 is rendered on the user interface 464. The user interface 464 may include a group management control 401, which, when selected, renders a UI object 470 of FIG. 4K (also shown in FIG. 3F, e.g., UI object 370) to view the groups 410 associated with the first user account and to edit group attributes (e.g., edit title, change icon, delete group, etc.) of a group 410.

Referring to FIG. 4K, the UI object 470 may display a list of the groups associated with the first user account, e.g., group 410a, group 410b, group 410c, group 410d, group 410e, and group 410f. A group 410 that is set to public may be indicated by an indicator 411 (e.g., “LIVE”). In the group list, the group 410a is identified as public by the indicator 411. Also, the UI object 470 may provide a plurality of controls that allows the user to manage the groups. For example, the UI object 470 may include a delete option 474, which, when selected by the user, causes the deletion of a respective group 410. The UI object 470 may include a pin control 476, which, when selected by the user, causes a respective group 410 to be displayed in the group list.

In some examples, the UI object 470 may include an edit group control 472, which, when selected by the user, renders a UI object (e.g., UI object 448 of FIGS. 4D, 4E, and 4G, or UI object 449 of FIG. 4F) to allow the user to edit attributes of the group. As shown in FIG. 4D, 4E, or 4G, the UI object 448 or 449 includes a text entry field 450 to allow the user to rename the title, an icon selection option 452 to allow the user to re-select an icon for the group, and a text entry field 454 to allow the user to enter a description of the group.

Referring to FIG. 41, after the group 410a is set to public, the user interface 464 may display, in the group list, an indicator 411 that indicates that the group 410a is public (or live). Referring to 4J, the application may display a UI object 473 that shows the information about the group 410a when the link to the group 410 (e.g., the resource locator identifier 107 of FIG. 1A) is selected. The information provided by UI object 473 may be displayed to other users of the messaging platform. For example, the UI object 473 may include an indicator 411 that indicates that the group 410a is set to public or live. Also, the UI object 473 may provide the title, the description, and the user account that owns (or created) the group 410a. In some examples, the UI object 473 may include the selectable link 432 to the group edit control, e.g., UI object 448 or UI object 449. For example, in response to selection to the selectable link 432, the UI object 448 or the UI object 449 is rendered on the user interface 464. Also, the UI object 473 may provide a selection to the group share control 442 that provides the sharing options for sharing the group 410a. As indicated above, the sharing options may include a first sharing option 462 for sending a direct message to one or more other user accounts, a second sharing option 463 for posting a message about the group 410a to the messaging platform, and a third sharing option 466 for copying a link to the group 410a.

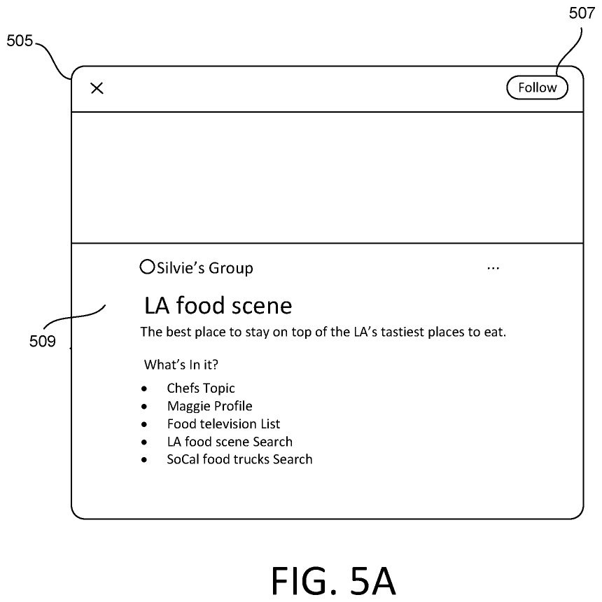

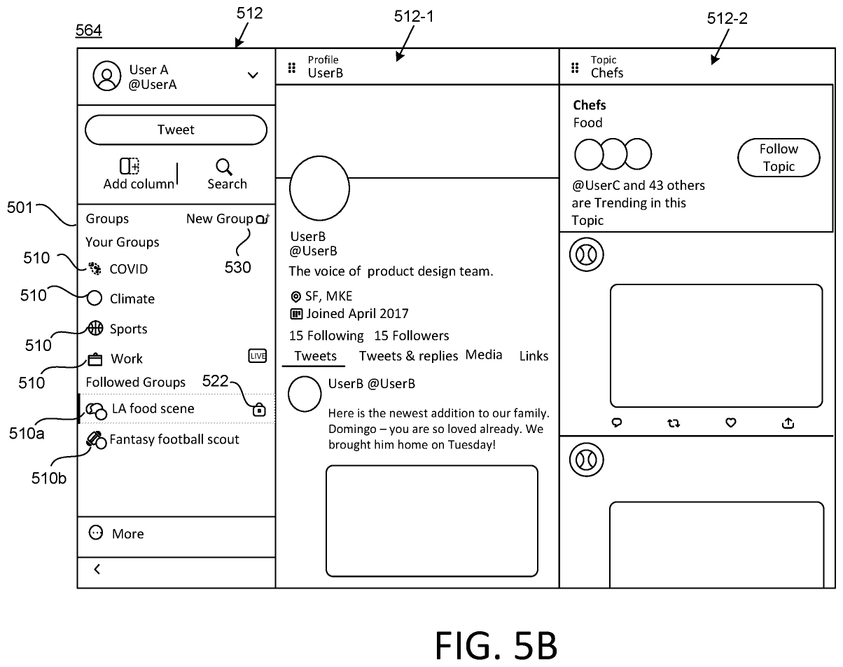

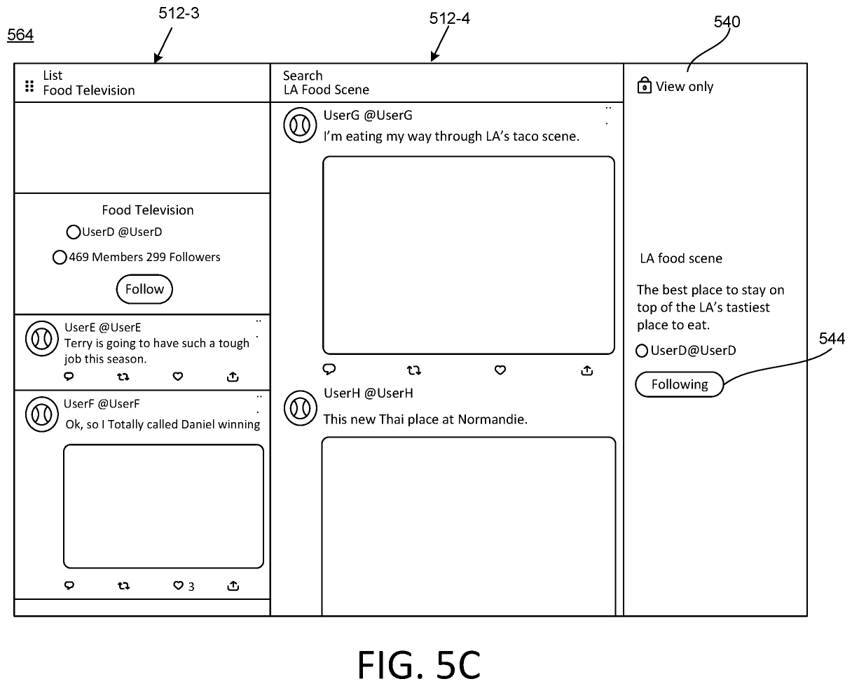

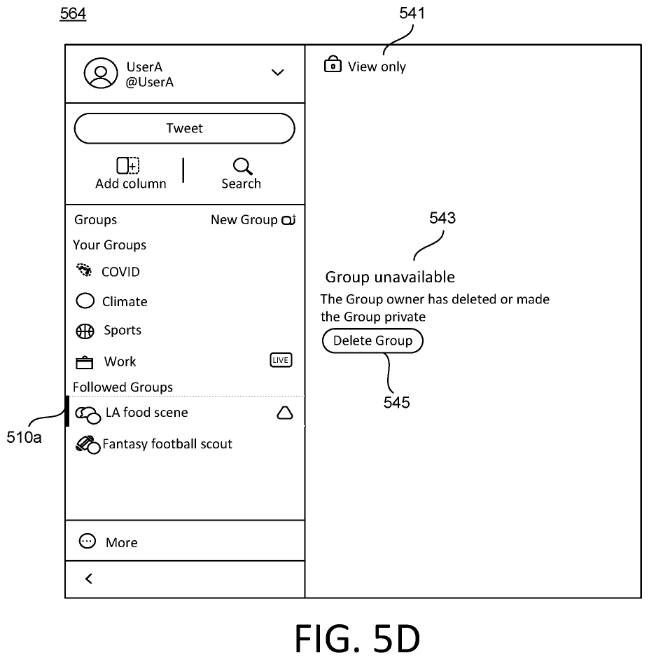

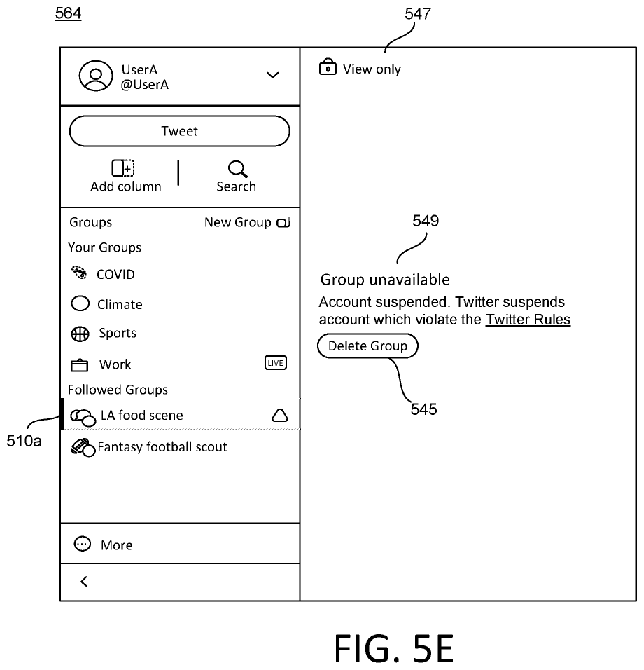

FIGS. 5A through 5E illustrate example user interfaces 564 provided by an application associated with a messaging platform. The user interfaces 564 may be examples of the user interface 164 of FIGS. 1A through 1G and may include any of the details discussed with reference to those figures. In some examples, the user interfaces may be provided by a viewing device (e.g., computing device 152-2 of FIG. 1A).

FIG. 5A illustrates a UI object 505 that may be rendered on the viewing device's user interface in response to receipt of the selection to the link to a shared group 510a (e.g., in response to selection of the resource locator identifier 107 of FIG. 1A). The UI object 505 may display information 509 about the shared group 510a such as the title of the shared group 510a, the description of the shared group 510a, the title of the display columns that belong to the shared group 510a, and an identification of the first user account that owns or created the shared group 510a. Also, the UI object 505 may display a follow selection control 507, which, when selected by the user, causes the shared group 510a to be associated with the second user account, and thereby available to be rendered on the computing device associated with the second user account.

As shown in FIGS. 5B and 5C, the user interface 564 displays the shared group 510a, where the shared group 510a includes the same display arrangement of the group 410a of FIGS. 4A through 4K. For example, the display arrangement (e.g., a multi-column layout) includes a display column 512-1 (as shown on FIG. 5B), a display column 512-2 (as shown on FIG. 5B), a display column 512-3 (as shown on FIG. 5C), and a display column 512-4 (as shown on FIG. 5C). The user interface 564 of FIGS. 5B and 5C may be a single interface that simultaneously displays the display column 512-1, the display column 512-2, the display column 512-3, and the display column 512-4 on the same display screen.

Also, the user interface 564 includes information 540 about the shared group 510a such as information that indicates that the shared group 510 can only be viewed, the title of the shared group 510a, the description of the shared group 510a, and/or identification of the user account that owns or created the shared group 510a. Also, the user interface 564 may include a follow indicator 544 that indicates that the second user account is following the shared group 510a.

As shown in FIG. 5B, the user interface 564 also displays a group list (e.g., the group list 166 of FIG. 1A). The group list identifies any groups 510 associated with the second user account (e.g., “Your Groups” or “Your Decks”). In some examples, the group list also identifies which groups 510 that the second user account is following (e.g., “Followed Groups” or “Followed Decks”), such as group 510a and group 510b. In some examples, the group list provides an icon that can identify a particular group 510. In some examples, the group list provides a title of each group 510. A user may select the shared group 510a from the group list, which causes the client application to render the display columns 512 associated with the shared group 510a, as shown in FIGS. 5B and 5C. In some examples, for followed groups (e.g., group 510a and group 510b), the user interface 564 may display an indicator 522 that indicates shared group 510a cannot be edited.

The user interface 564 may include a group creation control 530, which, when selected, renders a UI object (e.g., the UI object 388 as shown in FIG. 3I) to permit the user to create a new group. The user interface 564 may include a group management control 501, which, when selected, renders a UI object (e.g., the UI object 370 as shown in FIG. 3F) to view the groups 510 associated with the second user account and to edit group attributes (e.g., edit title, change icon, delete group, etc.) of a group 510.

In some examples, the owner (e.g., the first user account) of the shared group 510a may delete the shared group 510 or change the sharing status (e.g., the sharing status 130 of FIG. 1D) to private. Referring to FIG. 5D, in response to selection of the shared group 510a from the group list, the application may render a UI object 541 (in replace of the display columns 512 of the shared group 510a) when the shared group 510a has been deleted or the sharing status has been changed to private. The UI object 541 may indicate a notification 543 that the group is unavailable along with a delete option 545 to delete the second user account association with the shared group 510a.

In some examples, the owner (e.g., the first user account) of the shared group 510a may have their account suspended. Referring to FIG. 5E, in response to selection of the shared group 510a from the group list, the application may render a UI object 547 (in replace of the display columns 512 of the shared group 510a) when the first user account has been suspended. The UI object 547 may provide a notification 549 that the group is unavailable because the owner's account has been suspended along with a delete option 545 to delete the second user account association with the shared group 510a.

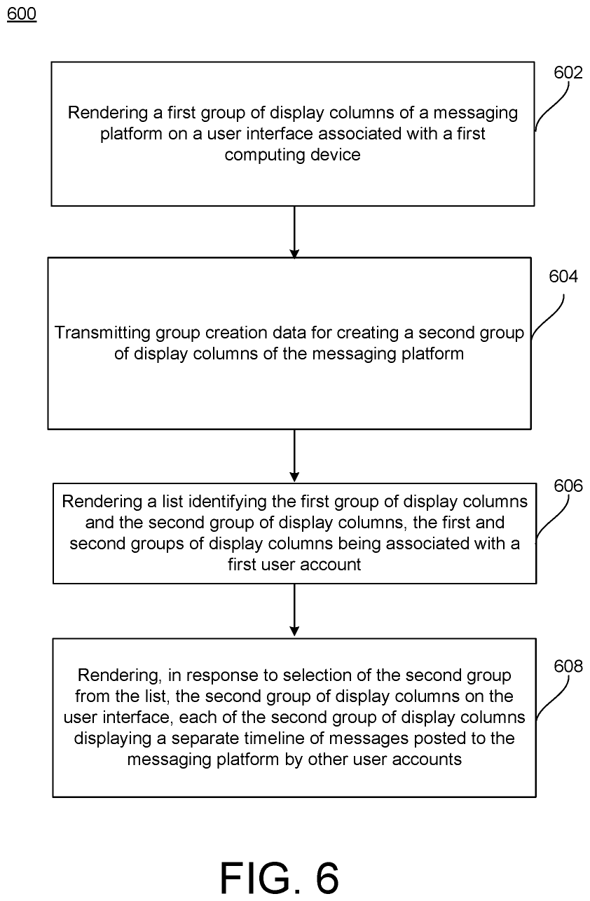

FIG. 6 is a flowchart 600 depicting example operations of managing groups of display columns of a messaging platform according to an aspect. Although the flowchart 600 is explained with respect to the messaging system of FIGS. 1A through 1G, the flowchart 600 may be applicable to any of the embodiments discussed herein. Although the flowchart 600 of FIG. 6 illustrates the operations in sequential order, it will be appreciated that this is merely an example, and that additional or alternative operations may be included. Further, operations of FIG. 6 and related operations may be executed in a different order than that shown, or in a parallel or overlapping fashion.

Operation 602 includes rendering a first group 110a of display columns 112 of a messaging platform 104 on a user interface 164 associated with a first computing device 152-1. Operation 604 includes transmitting group creation data 111 for creating a second group 110b of display columns 112 of the messaging platform 104. Operation 606 includes rendering a list (e.g., group list 166) identifying the first group 110a of display columns 112 and the second group 110b of display columns 112, the first and second groups of display columns being associated with a first user account 108a. Operation 608 includes rendering, in response to selection of the second group 110b from the list, the second group 110b of display columns 112 on the user interface 164, each of the second group 110b of display columns 112 displaying a separate timeline of messages 120 posted to the messaging platform 104 by other user accounts 108.

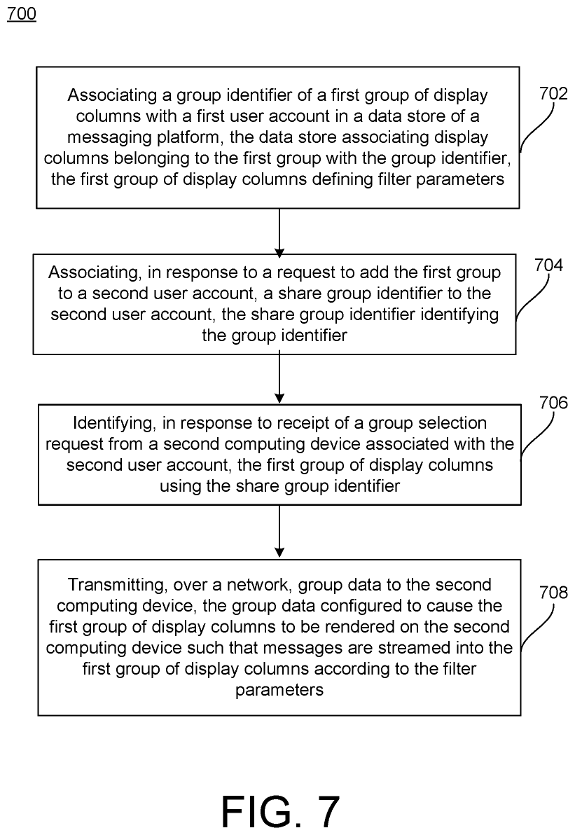

FIG. 7 is a flowchart 700 depicting example operations of managing groups of display columns of a messaging platform according to an aspect. Although the flowchart 700 is explained with respect to the messaging system of FIGS. 1A through 1G, the flowchart 700 may be applicable to any of the embodiments discussed herein. Although the flowchart 700 of FIG. 7 illustrates the operations in sequential order, it will be appreciated that this is merely an example, and that additional or alternative operations may be included. Further, operations of FIG. 7 and related operations may be executed in a different order than that shown, or in a parallel or overlapping fashion.

Operation 702 includes associating a group identifier 128 of a first group 110a of display columns 112 with a first user account 108a in a data store 106 of a messaging platform 104, the data store 106 associating display columns 112 belonging to the first group 110a with the group identifier 128, the first group 110a of display columns 112 defining filter parameters (e.g., attributes 155). Operation 704 includes associating, in response to a request (e.g., follow request 121) to add the first group 110a to a second user account 108b, a share group identifier 132 to the second user account 108b, the share group identifier 132 identifying the group identifier 128. Operation 706 includes identifying, in response to receipt of a group selection request 115 from a second computing device 152-2 associated with the second user account 108b, the first group 110a of display columns 112 using the share group identifier 132. Operation 708 includes transmitting, over a network, group data 117 to the second computing device 152-2, the group data 117 configured to cause the first group 110a of display columns 112 to be rendered on the second computing device 152-2 such that messages 120 are streamed into the first group 110a of display columns 112 according to the filter parameters.

Although the disclosed concepts include those defined in the attached claims, it should be understood that the concepts can also be defined in accordance with the following examples.

Example 1 is a method for managing groups of display columns in a messaging platform, the method comprising rendering a first group of display columns of a messaging platform on a user interface associated with a first computing device; transmitting group creation data for creating a second group of display columns of the messaging platform; rendering a list identifying the first group of display columns and the second group of display columns, the first and second groups of display columns being associated with a first user account; and rendering, in response to selection of the second group from the list, the second group of display columns on the user interface, each of the second group of display columns displaying a separate timeline of messages posted to the messaging platform by other user accounts.

Example 2 is the method of Example 1, further comprising: rendering a first user interface (UI) object on the user interface, the first UI object providing an option to add a first display column to the second group.

Example 3 is the method of any of Examples 1 to 2, further comprising: rendering a second UI object on the user interface, the second UI object providing an option to define a plurality of filter parameters of the first display column.

Example 4 is the method of any of Examples 1 to 3, wherein the group creation data includes one or more of the plurality of filter parameters.

Example 5 is the method of any of Examples 1 to 4, further comprising: rendering, in response to selection of the first group from the list, the first group of display columns on the user interface in replace of the second group of display columns, each of the first group of display columns displaying a separate timeline of messages posted to the messaging platform by other user accounts.

Example 6 is the method of any of Examples 1 to 5, further comprising: rendering a user interface (UI) object on the user interface, the UI object providing an option to share a display column of the second group with other users of the messaging platform.

Example 7 is the method of any of Examples 1 to 6, further comprising: transmitting, over a network, a message to a second computing device associated with a second user account.

Example 8 is the method of any of Examples 1 to 7, wherein the message includes a resource locator identifier, which, when selected, is configured to provide an option to add the display column of the second group to a user account of the messaging platform.

Example 9 is the method of any of Examples 1 to 8, further comprising: rendering a user interface (UI) object on the user interface, the UI object providing an option to share the second group with other users of the messaging platform.

Example 10 is the method of any of Examples 1 to 9, further comprising: transmitting, over a network, a message to a second computing device associated with a second user account, the message including a resource locator identifier, which, when selected, is configured to provide an option to add the second group to a user account of the messaging platform.

Example 11 is the method of any of Examples 1 to 10, wherein the first group of display columns is created by a second user account of the messaging platform.

Example 12 is the method of any of Examples 1 to 11, further comprising: rendering a message on the user interface, the message having been posted to the messaging platform by a second user account, the message including a resource locator identifier.

Example 13 is the method of any of Examples 1 to 12, further comprising: rendering, in response to selection of the resource locator identifier, a user interface (UI) object that provides an option to add the first group of display columns to the first user account.

Example 14 is the method of any of Examples 1 to 13, further comprising: identifying the first group of display columns in the list in response to selection of the option to add the first group of display columns to the first user account.

Example 15 is the method of any of Examples 1 to 14, wherein one or more attributes of a display column belonging to the first group are not modifiable by the first user account.

Example 16 is the method of any of Examples 1 to 15, further comprising: providing selection of one or more of a plurality of groups of display columns offered by a store platform, the plurality of groups of display columns being available to be added to the first user account.

Example 17 is the method of any of Examples 1 to 16, further comprising: receiving a selection to a third group of display columns from the plurality of groups of display columns offered by the store platform.

Example 18 is the method of any of Examples 1 to 17, further comprising: identifying the third group of display columns in the list on the user interface.

Example 19 is a system comprising one or more computers and one or more storage devices storing instructions that are operable, when executed by the one or more computers, to cause the one or more computers to perform the method of any of Examples 1 to 18.

Example 20 is a computer storage medium encoded with a computer program, the program comprising instructions that are operable, when executed by a data processing apparatus, to cause the data processing apparatus to perform the method of any of Examples 1 to 18.

Example 21 is an apparatus comprising: means for rendering a first group of display columns of a messaging platform on a user interface associated with a first computing device; means for transmitting group creation data for creating a second group of display columns of the messaging platform; rendering a list identifying the first group of display columns and the second group of display columns, the first and second groups of display columns being associated with a first user account; and means for rendering, in response to selection of the second group from the list, the second group of display columns on the user interface, each of the second group of display columns displaying a separate timeline of messages posted to the messaging platform by other user accounts

Example 22 is an apparatus comprising: at least one processor; and a non-transitory computer-readable medium storing executable instructions that when executed by the at least one processor cause the at least one processor to: associate a group identifier of a first group of display columns with a first user account in a data store of a messaging platform, the data store associating display columns belonging to the first group with the group identifier, the first group of display columns defining filter parameters; associate, in response to a request to add the first group to a second user account, a share group identifier to the second user account, the share group identifier identifying the group identifier; identify, in response to receipt of a group selection request from a second computing device associated with the second user account, the first group of display columns using the share group identifier; and transmit, over a network, group data to the second computing device, the group data configured to cause the first group of display columns to be rendered on the second computing device such that messages are streamed into the first group of display columns according to the filter parameters.

Example 23 is the apparatus of Example 22, wherein the first group of display columns is shared with the second user account using the share group identifier such that the display columns belonging to the first group are not duplicated and stored in association with the second user account in the data store.

Example 24 is the apparatus of any of Examples 22 to 23, wherein the executable instructions include instructions that when executed by the at least one processor cause the at least one processor to: transmit, over a network, a message to the second computing device, the message including a resource locator identifier, which, when selected, is configured to provide an option to add the first group to the second user account.

Example 25 is the apparatus of any of Examples 22 to 24, wherein the executable instructions include instructions that when executed by the at least one processor cause the at least one processor to: update a profile of the first user account to display information about the first group, the information about the first group including the resource locator identifier.

Example 26 is the apparatus of any of Examples 22 to 25, wherein the filter parameters of the first group of display columns are not modifiable by the second user account.

Example 27 is the apparatus of any of Examples 22 to 26, wherein the filter parameters of the first group of display columns are modifiable by the first user account.

Example 28 is the apparatus of any of Examples 22 to 27, wherein the executable instructions include instructions that when executed by the at least one processor cause the at least one processor to: identify that the group selection request is from the second user account.

Example 29 is the apparatus of any of Examples 22 to 28, wherein the executable instructions include instructions that when executed by the at least one processor cause the at least one processor to: determine that the share group identifier is associated with the second user account from the data store.

Example 30 is the apparatus of any of Examples 22 to 29, wherein the executable instructions include instructions that when executed by the at least one processor cause the at least one processor to: identify the group identifier from the data store using the share group identifier.

Example 31 is the apparatus of any of Examples 22 to 30, wherein the executable instructions include instructions that when executed by the at least one processor cause the at least one processor to: identify column identifiers of the display columns belonging to the first group from the data store using the group identifier.

Example 32 is the apparatus of any of Examples 22 to 31, wherein the executable instructions include instructions that when executed by the at least one processor cause the at least one processor to: obtain attributes of the first group of display columns from the data store using the column identifiers, the attributes including the filter parameters.

Example 33 is the apparatus of any of Examples 22 to 32, wherein the first group of display columns include a first display column that displays messages posted to the messaging platform that satisfy a first search query and a second display column that displays messages posted to the messaging platform that satisfy a second search query.

Example 34 is the apparatus of any of Examples 22 to 33, wherein the first display column and the second display column are configured to be displayed simultaneously.

Example 35 is a method that includes operations of the apparatus according to any of Examples 22 to 34.

Example 36 is a computer storage medium encoded with a computer program, the program comprising instructions that are operable, when executed by a data processing apparatus, to cause the data processing apparatus to perform the operations of the apparatus according to any of Examples 22 to 34.

Example 37 is an apparatus comprising: means for associating a group identifier of a first group of display columns with a first user account in a data store of a messaging platform, the data store associating display columns belonging to the first group with the group identifier, the first group of display columns defining filter parameters; means for associating, in response to a request to add the first group to a second user account, a share group identifier to the second user account, the share group identifier identifying the group identifier; means for identifying, in response to receipt of a group selection request from a second computing device associated with the second user account, the first group of display columns using the share group identifier; and means for transmitting, over a network, group data to the second computing device, the group data configured to cause the first group of display columns to be rendered on the second computing device such that messages are streamed into the first group of display columns according to the filter parameters.

Example 38 is a non-transitory computer-readable medium storing executable instructions that when executed by at least one processor cause the at least one processor to execute operations, the operations comprising: receive, over a network, group creation data for creating a first group of display columns of a messaging platform from a client application executable by a first computing device; update a data store of the messaging platform to associate a user account with the first group of display columns, the user account being associated with a second group of display columns; and transmit, over the network, group list data to the client application, the group list data configured to cause the client application to render a list identifying the first group of display columns and the second group of display columns.

Example 39 is the non-transitory computer-readable medium of Example 38, wherein the second group of display columns is created by a second user account associated with a second computing device.

Example 40 is the non-transitory computer-readable medium of any of Examples 38 to 39, wherein the operations comprise: transmit, over the network, a message to the second computing device, the message including a resource locator identifier, which, when selected, is configured to provide an option to add the first group to the second user account.

Example 41 is the non-transitory computer-readable medium of any of Examples 38 to 40, wherein the operations comprise: update, in response to receipt of the option to add the first group, the data store to associate the second user account with the first group.

Example 42 is the non-transitory computer-readable medium of any of Examples 38 to 41, wherein the operations comprise: transmit, in response to receipt of a group selection request from the second computing device, group data to the second computing device.

Example 43 is the non-transitory computer-readable medium of any of Examples 38 to 42, wherein the group data is configured to cause the first group of display columns to be rendered on the second computing device such that messages are streamed into the first group of display columns.

Example 44 is a method that includes operations (or steps) of the non-transitory computer-readable medium of any of Examples 38 to 43.

Example 45 is an apparatus comprising: at least one processor; and a non-transitory computer-readable medium storing executable instructions that when executed by the at least one processor cause the at least one processor to perform the operations of any of Examples 38 to 43.

Example 46 is an apparatus comprising: means for receiving, over a network, group creation data for creating a first group of display columns of a messaging platform from a client application executable by a first computing device; means for updating a data store of the messaging platform to associate a user account with the first group of display columns, the user account being associated with a second group of display columns; and means for transmitting, over the network, group list data to the client application, the group list data configured to cause the client application to render a list identifying the first group of display columns and the second group of display columns.

Example 47 includes a method for managing groups of display columns in a messaging platform, the method comprising: transmitting group creation data for creating a first group of display columns of a messaging platform, the first group of display columns being associated with a first user account of the messaging platform; rendering a list identifying the first group of display columns and a second group of display columns on a user interface; and rendering, in response to selection of the first group from the list, the first group of display columns on the user interface, each of the first group of display columns displaying a separate timeline of messages to the messaging platform by other user accounts.

Example 48 is the method of Example 47, further comprising any of Examples 2 to 18.

Example 49 is a system comprising one or more computers and one or more storage devices storing instructions that are operable, when executed by the one or more computers, to cause the one or more computers to perform the method of any of Examples 47 to 48.

Example 49 is a computer storage medium encoded with a computer program, the program comprising instructions that are operable, when executed by a data processing apparatus, to cause the data processing apparatus to perform the method of any of Examples 47 to 48.

Example 50 is an apparatus comprising: means for transmitting group creation data for creating a first group of display columns of a messaging platform, the first group of display columns being associated with a first user account of the messaging platform; means for rendering a list identifying the first group of display columns and a second group of display columns on a user interface; and means for rendering, in response to selection of the first group from the list, the first group of display columns on the user interface, each of the first group of display columns displaying a separate timeline of messages to the messaging platform by other user accounts.

In the above description, numerous details are set forth. It will be apparent, however, to one of ordinary skill in the art having the benefit of this disclosure, that implementations of the disclosure may be practiced without these specific details. In some instances, well-known structures and devices are shown in block diagram form, rather than in detail, in order to avoid obscuring the description.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here and generally conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying,” “determining,” “calculating,” “updating,” “transmitting,” “receiving,” “generating,” “changing,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Implementations of the disclosure also relate to an apparatus for performing the operations herein. This apparatus may be specially constructed for the required purposes, or it may comprise a general-purpose computer selectively activated or reconfigured by a computer program stored in the computer. Such a computer program may be stored in a non-transitory computer readable storage medium, such as, but not limited to, any type of disk including floppy disks, optical disks, CD-ROMs and magnetic-optical disks, read-only memories (ROMs), random access memories (RAMs), EPROMs, EEPROMs, magnetic or optical cards, flash memory, or any type of media suitable for storing electronic instructions.

The words “example” or “exemplary” are used herein to mean serving as an example, instance, or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not necessarily have an ordinal meaning according to their numerical designation.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the present disclosure is not described with reference to any particular programming language. It will be appreciated that a variety of programming languages may be used to implement the teachings of the disclosure as described herein.

The above description sets forth numerous specific details such as examples of specific systems, components, methods and so forth, in order to provide a good understanding of several implementations of the present disclosure. It will be apparent to one skilled in the art, however, that at least some implementations of the present disclosure may be practiced without these specific details. In other instances, well-known components or methods are not described in detail or are presented in simple block diagram format in order to avoid unnecessarily obscuring the present disclosure. Thus, the specific details set forth above are merely examples. Particular implementations may vary from these example details and still be contemplated to be within the scope of the present disclosure.

What is claimed is:

1. A method for managing groups of display columns in a messaging platform, the method comprising:
rendering a first group of display columns of a messaging platform on a user interface associated with a first computing device;
transmitting group creation data for creating a second group of display columns of the messaging platform;
rendering a list identifying the first group of display columns and the second group of display columns, the first and second groups of display columns being associated with a first user account; and
rendering, in response to selection of the second group from the list, the second group of display columns on the user interface, each of the second group of display columns displaying a separate timeline of messages posted to the messaging platform by other user accounts.

2. The method of claim 1, further comprising:
rendering a first user interface (UI) object on the user interface, the first UI object providing an option to add a first display column to the second group; and
rendering a second UI object on the user interface, the second UI object providing an option to define a plurality of filter parameters of the first display column, wherein the group creation data includes one or more of the plurality of filter parameters.

3. The method of claim 1, further comprising:
rendering, in response to selection of the first group from the list, the first group of display columns on the user interface in replace of the second group of display columns, each of the first group of display columns displaying a separate timeline of messages posted to the messaging platform by other user accounts.

4. The method of claim 1, further comprising:
rendering a user interface (UI) object on the user interface, the UI object providing an option to share a display column of the second group with other users of the messaging platform; and
transmitting, over a network, a message to a second computing device associated with a second user account, the message including a resource locator identifier, which, when selected, is configured to provide an option to add the display column of the second group to a user account of the messaging platform.

5. The method of claim 1, further comprising:
rendering a user interface (UI) object on the user interface, the UI object providing an option to share the second group with other users of the messaging platform; and
transmitting, over a network, a message to a second computing device associated with a second user account, the message including a resource locator identifier, which, when selected, is configured to provide an option to add the second group to a user account of the messaging platform.

6. The method of claim 1, wherein the first group of display columns is created by a second user account of the messaging platform.

7. The method of claim 1, further comprising:
rendering a message on the user interface, the message having been posted to the messaging platform by a second user account, the message including a resource locator identifier;
rendering, in response to selection of the resource locator identifier, a user interface (UI) object that provides an option to add the first group of display columns to the first user account; and
identifying the first group of display columns in the list in response to selection of the option to add the first group of display columns to the first user account.

8. The method of claim 7, wherein one or more attributes of a display column belonging to the first group are not modifiable by the first user account.

9. The method of claim 1, further comprising:
providing selection of one or more of a plurality of groups of display columns offered by a store platform, the plurality of groups of display columns being available to be added to the first user account;
receiving a selection to a third group of display columns from the plurality of groups of display columns offered by the store platform; and
identifying the third group of display columns in the list on the user interface.

10. An apparatus comprising:
at least one processor; and
a non-transitory computer-readable medium storing executable instructions that when executed by the at least one processor cause the at least one processor to:
associate a group identifier of a first group of display columns with a first user account in a data store of a messaging platform, the data store associating display columns belonging to the first group with the group identifier, the first group of display columns defining filter parameters;
associate, in response to a request to add the first group to a second user account, a share group identifier to the second user account, the share group identifier identifying the group identifier;
identify, in response to receipt of a group selection request from a second computing device associated with the second user account, the first group of display columns using the share group identifier; and
transmit, over a network, group data to the second computing device, the group data configured to cause the first group of display columns to be rendered on the second computing device such that messages are streamed into the first group of display columns according to the filter parameters.

11. The apparatus of claim 10, wherein the first group of display columns is shared with the second user account using the share group identifier such that the display columns belonging to the first group are not duplicated and stored in association with the second user account in the data store.

12. The apparatus of claim 11, wherein the executable instructions include instructions that when executed by the at least one processor cause the at least one processor to:
transmit, over a network, a message to the second computing device, the message including a resource locator identifier, which, when selected, is configured to provide an option to add the first group to the second user account.

13. The apparatus of claim 12, wherein the executable instructions include instructions that when executed by the at least one processor cause the at least one processor to:
update a profile of the first user account to display information about the first group, the information about the first group including the resource locator identifier.

14. The apparatus of claim 11, wherein the filter parameters of the first group of display columns are not modifiable by the second user account.

15. The apparatus of claim 11, wherein the filter parameters of the first group of display columns are modifiable by the first user account.

16. The apparatus of claim 11, wherein the executable instructions include instructions that when executed by the at least one processor cause the at least one processor to:
identify that the group selection request is from the second user account;
determine that the share group identifier is associated with the second user account from the data store;
identify the group identifier from the data store using the share group identifier;
identify column identifiers of the display columns belonging to the first group from the data store using the group identifier; and
obtain attributes of the first group of display columns from the data store using the column identifiers, the attributes including the filter parameters.

17. The apparatus of claim 10, wherein the first group of display columns include a first display column that displays messages posted to the messaging platform that satisfy a first search query and a second display column that displays messages posted to the messaging platform that satisfy a second search query, wherein the first display column and the second display column are configured to be displayed simultaneously.

18. A non-transitory computer-readable medium storing executable instructions that when executed by at least one processor cause the at least one processor to execute operations, the operations comprising:
receive, over a network, group creation data for creating a first group of display columns of a messaging platform from a client application executable by a first computing device;
update a data store of the messaging platform to associate a user account with the first group of display columns, the user account being associated with a second group of display columns; and
transmit, over the network, group list data to the client application, the group list data configured to cause the client application to render a list identifying the first group of display columns and the second group of display columns.

19. The non-transitory computer-readable medium of claim 18, wherein the second group of display columns is created by a second user account associated with a second computing device.

20. The non-transitory computer-readable medium of claim 19, wherein the operations comprise:
transmit, over the network, a message to the second computing device, the message including a resource locator identifier, which, when selected, is configured to provide an option to add the first group to the second user account;
update, in response to receipt of the option to add the first group, the data store to associate the second user account with the first group; and
transmit, in response to receipt of a group selection request from the second computing device, group data to the second computing device, the group data configured to cause the first group of display columns to be rendered on the second computing device such that messages are streamed into the first group of display columns.

21. A method for managing groups of display columns in a messaging platform, the method comprising:
transmitting group creation data for creating a first group of display columns of a messaging platform, the first group of display columns being associated with a first user account of the messaging platform;
rendering a list identifying the first group of display columns and a second group of display columns on a user interface; and
rendering, in response to selection of the first group from the list, the first group of display columns on the user interface, each of the first group of display columns displaying a separate timeline of messages to the messaging platform by other user accounts.
